(19) United States
(12) Patent Application Publication
(10) Pub. No.: US 2025/0297852 A1
(43) Pub. Date: Sep. 25, 2025

(54) OPTICAL INSPECTION APPARATUS, OPTICAL INSPECTION METHOD, AND NON-TRANSITORY STORAGE MEDIUM STORING OPTICAL INSPECTION PROGRAM

(71) Applicant: KABUSHIKI KAISHA TOSHIBA, Tokyo (JP)

(72) Inventor: Hiroshi OHNO, Tokyo (JP)

(73) Assignee: KABUSHIKI KAISHA TOSHIBA, Tokyo (JP)

(21) Appl. No.: 19/061,585

(22) Filed: Feb. 24, 2025

(30) Foreign Application Priority Data
Mar. 21, 2024 (JP) 2024-045129

(51) Int. Cl. G01B 11/24; G06T 7/586

(52) U.S. Cl. CPC G01B 11/24; G06T 7/586; G06T 2207/10152

(57) ABSTRACT

According to an embodiment, an optical inspection apparatus includes an illumination portion, an imaging portion, and a processor. The illumination portion is configured to irradiate a first object point of an object with a light beam flux at one or more solid angles. The imaging portion is configured to acquire an image of the object according to illumination with the light beam flux. The processor causes the first object point to be irradiated with a light beam flux at a first solid angle by first illumination light, acquires a first captured image of the object with the first illumination light, causes the first object point to be irradiated with light beam fluxes at the third and fourth solid angles by second illumination light, acquires a second captured image of the object with the second illumination light, and acquires information regarding the object by the first and second captured images.

### CROSS-REFERENCE TO RELATED APPLICATIONS

This application is based upon and claims the benefit of priority from Japanese Patent Application No. 2024-045129, filed Mar. 21, 2024, the entire contents of all of which are incorporated herein by reference.

### FIELD

Embodiments described herein relate generally to an optical inspection apparatus, an optical inspection method, and a non-transitory storage medium storing an optical inspection program.

### BACKGROUND

Contactless inspection of objects is important in various industries. In a conventional method, there is a method in which a color (wavelength spectrum) of a light beam separated using a diffraction grating or a wavelength filter is made to correspond to a light beam direction on a one-to-one basis, the direction of the light beam is identified by specifying the color, and information regarding an object surface or in an object is acquired.

### BRIEF DESCRIPTION OF THE DRAWINGS

FIG. 1 is a schematic diagram illustrating an optical inspection apparatus according to a first embodiment.

FIG. 2 is a schematic block diagram of the optical inspection apparatus according to the embodiment.

FIG. 3 is a processing procedure for acquiring information regarding an object using the optical inspection apparatus according to the first embodiment.

FIG. 4 is a schematic diagram illustrating the optical inspection apparatus according to Modification 1 of the first embodiment.

FIG. 5 is a processing procedure for acquiring information regarding the object using the optical inspection apparatus according to Modification 2 of the first embodiment.

FIG. 6 is a schematic diagram illustrating an optical inspection apparatus according to a second embodiment.

FIG. 7 is a schematic diagram illustrating an optical inspection apparatus according to a third embodiment.

FIG. 8 is a schematic diagram illustrating an optical inspection apparatus according to a fourth embodiment.

FIG. 9 is a schematic diagram illustrating projection patterns from an illumination portion of the optical inspection apparatus according to Modification 4 of the fourth embodiment, in which (A) illustrates a first projection pattern, and (B) illustrates a second projection pattern.

FIG. 10 is a schematic diagram illustrating projection patterns from the illumination portion of the optical inspection apparatus according to Modification 5 of the fourth embodiment, in which (A) illustrates a first projection pattern, and (B) illustrates a second projection pattern.

FIG. 11 is a schematic diagram illustrating projection patterns from the illumination portion of the optical inspection apparatus according to Modification 6 of the fourth embodiment, in which (A) illustrates a first projection pattern, and (B) illustrates a second projection pattern.

FIG. 12 is a schematic diagram illustrating projection patterns from the illumination portion of the optical inspection apparatus according to Modification 7 of the fourth embodiment, in which (A) illustrates a first projection pattern, and (B) illustrates a second projection pattern.

FIG. 13 is a schematic diagram illustrating Application Example 1 in which optical inspection of the object is performed using the projection patterns of Modification 4 of the fourth embodiment in the optical inspection apparatus according to the fourth embodiment.

FIG. 14 is a schematic diagram illustrating Application Example 2 in which optical inspection of the object is performed using the projection patterns of Modification 4 of the fourth embodiment in the optical inspection apparatus according to the fourth embodiment.

FIG. 15 is a schematic diagram illustrating Application Example 3 in which optical inspection of the object is performed using the projection patterns of Modification 4 of the fourth embodiment in the optical inspection apparatus according to the fourth embodiment.

### DETAILED DESCRIPTION

Hereinafter, each embodiment will be described with reference to the drawings. The drawings are schematic or conceptual, and a relationship between a thickness and a width of each portion, a ratio of sizes of portions, and the like are not necessarily the same as actual ones. In addition, even in the case of representing the same portion, dimensions and ratios may be represented differently from each other depending on the drawings. In the present specification and each drawing, the same elements as those described in relation to already described drawings are denoted by the same reference numerals, and the detailed description thereof is appropriately omitted.

In the present specification, it is assumed that light is a type of electromagnetic wave, and includes a gamma ray, an X-ray, an ultraviolet ray, visible light, an infrared ray, a radio wave, and the like. In the present embodiment, it is assumed that light is visible light, and for example, a wavelength of the light is in a region of 400 nm to 800 nm.

An object of an embodiment is to provide an optical inspection apparatus, an optical inspection method, and a non-transitory storage medium storing an optical inspection program, which are capable of acquiring information regarding an object with illumination of a small number of colors (wavelength spectrum).

According to the embodiment, an optical inspection apparatus includes: an illumination portion, an imaging portion, and a processor. The illumination portion is configured to irradiate at least a first object point of an object with a light beam flux at one or a plurality of solid angles. The imaging portion is configured to acquire an image of the object according to illumination with the light beam flux at the one or plurality of solid angles. The processor causes the first object point of the object to be irradiated with a light beam flux at a first solid angle by first illumination light from the illumination portion, and is configured to set a solid angle not including the first solid angle as a second solid angle, that is configured to acquire a first captured image of the object using the imaging portion by illumination with the first illumination light, that is configured to set a solid angle included in the first solid angle as a third solid angle, is configured to set a solid angle included in the second solid angle as a fourth solid angle, causes at least the first object point to be irradiated with light beam fluxes at the third solid angle and the fourth solid angle by second illumination light from the illumination portion, that is configured to acquire a second captured image of the object using the imaging portion by illumination with the second illumination light, and that is configured to acquire information regarding the object by the first captured image and the second captured image.

### First Embodiment

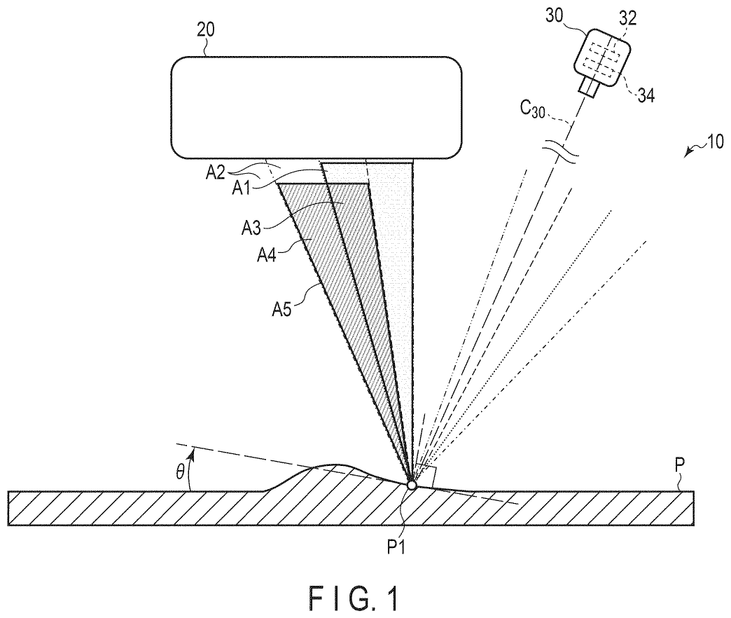

An optical inspection apparatus 10 according to the present embodiment will be described below with reference to FIGS. 1 to 3.

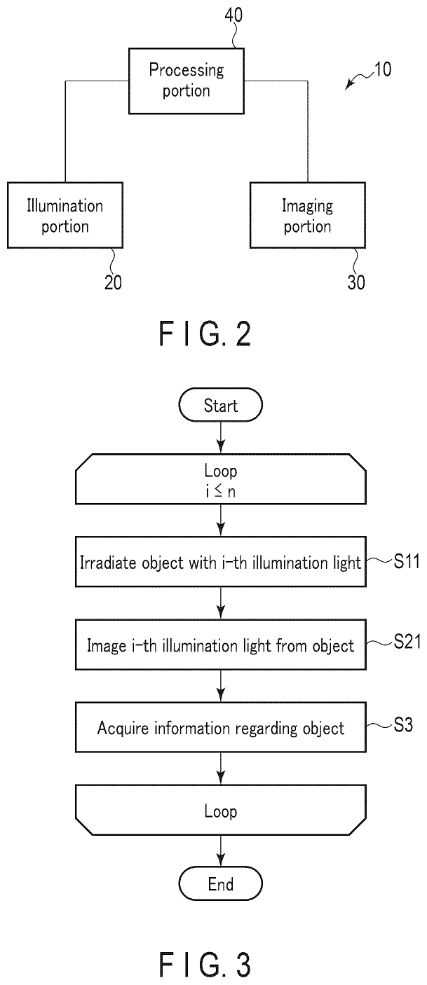

FIG. 1 is a schematic cross-sectional view of the optical inspection apparatus 10 according to the present embodiment. FIG. 2 is a schematic block diagram of the optical inspection apparatus 10 according to the present embodiment.

As illustrated in FIGS. 1 and 2, the optical inspection apparatus 10 according to the present embodiment includes an illumination portion 20, an imaging portion 30, and a processing portion 40.

The illumination portion 20 can emit light having at least a first wavelength spectrum from a light source. The wavelength spectrum means an intensity distribution of the light with respect to a wavelength. Two wavelength spectra being different means that intensity distributions with respect to wavelengths are different from each other. For example, a wavelength spectrum having a wavelength of 450 nm as a peak is different from a wavelength spectrum having a wavelength of 650 nm as a peak. The first wavelength spectrum emitted by the illumination portion 20 may be any wavelength spectrum. In the present embodiment, it is assumed that light having the first wavelength spectrum is white light having a peak wavelength of 550 nm.

The light source of the illumination portion 20 may be a white light source such as a white light-emitting diode (LED), a halogen lamp, a fluorescent lamp, an incandescent lamp, a high-intensity discharge lamp (HID lamp), or a metal halide lamp. In the present embodiment, it is assumed that the light source is a white LED. However, the light source is not limited thereto, and may be a monochromatic laser. Alternatively, a plurality of monochromatic lasers of various colors may be arranged.

The imaging portion 30 uses an image sensor 32 and an imaging optical element 34, and is configured to form an image of light on the image sensor 32 by the imaging optical element 34. The imaging optical element 34 may be, for example, a single lens, an assembled lens including a plurality of lenses, a Fresnel lens, a fly-eye lens, a microlens array, a concave mirror, a diffraction grating, a gradient index lens (GRIN lens), or the like. That is, as the imaging optical element 34, any element may be used as long as the element can image light. A surface on which a set of points at infinity is imaged by the imaging optical element 34 is a focal plane f₃₀. The optical axis C₃₀ of the imaging optical element 34 is a straight line orthogonal to the focal plane f₃₀, and light emitted from a point on the straight line is imaged on the straight line again. In the present embodiment, it is assumed that the imaging optical element 34 is an assembled lens.

In the present specification, the imaging optical element 34 for imaging is particularly referred to as an imaging optical element configured to image the object, and an imaging optical element 24 for illumination is referred to as an imaging optical element configured to illuminate the object. In addition, the optical axis of the imaging optical element 34 for imaging is the imaging optical axis C₃₀, and the optical axis of the imaging optical element 24 for illumination is an illumination optical axis C₂₀. Furthermore, the focal planes of the imaging optical elements 34 and 24 are an imaging focal plane f₃₀ and an illumination focal plane f₂₀, respectively.

The object P may transmit or reflect light. Alternatively, the object P may be translucent. A point on the surface of the object P or a point inside the object P is referred to as an object point. Hereinafter, unless otherwise specified, it is assumed that the object P reflects light and that the object point is on the surface of the object P. The surface of the object P may be referred to as an object surface. In the present embodiment, it is assumed that the object P is reflective and reflects light on the surface. Therefore, the object point is present on the surface of the object. However, the object P is not limited thereto.

In the present embodiment, white light is used as illumination light as described above. The image sensor 32 according to the present embodiment can use, for example, a monochrome camera that can detect white/black as a difference in light intensity, a color camera, or the like.

The processing portion 40 controls the illumination portion 20 and the imaging portion 30. The processing portion 40 is, for example, a computer. The processing portion 40 includes a processor or an integrated circuit (control circuit) including a central processing unit (CPU), an application specific integrated circuit (ASIC), a field programmable gate array (FPGA), or the like, and a storage medium such as a memory. The processor or the integrated circuit provided in the processing portion 40 may be one or a plurality of processors or integrated circuits. The processing portion 40 executes processing by executing a program or the like stored in the storage medium or the like. For example, an example of the program is an optical inspection program for the object P. The optical inspection program for the object P is stored in a non-transitory storage medium.

Furthermore, in the processing portion 40, the program that is executed by the processor may be stored in a computer (server), a server in a cloud environment, or the like connected via a network such as the Internet. In this case, the processing portion 40 downloads the program via the network.

As long as the processing portion 40 can appropriately control the illumination portion 20 and the imaging portion 30, the processing portion 40 may be located at a position far from the optical inspection apparatus 10 regardless of whether the processing portion 40 is located within or outside the country where the illumination portion 20 and the imaging portion 30 are located.

An operation of the optical inspection apparatus 10 according to the present embodiment will be described using a processing procedure illustrated in FIG. 3 based on the above-described configuration.

The processing portion 40 irradiates at least a first object point P1 on the object surface P with light having the first wavelength spectrum as first illumination light from the illumination portion 20. Furthermore, the processing portion 40 causes the imaging portion 30 to acquire an image at a viewpoint sufficiently far from the object P. That is, the processing portion 40 causes the first illumination light from the object P to be imaged. In this case, a light beam acquired by the imaging portion 30 can be regarded as being substantially parallel to the imaging optical axis C₃₀.

However, the processing portion 40 is not limited thereto, and causes at least the first object point P1 on the object surface P to be irradiated with light having the first wavelength spectrum as the first illumination light from the illumination portion 20. Then, immediately thereafter, the illumination portion 20 may cause the imaging portion 30 to acquire an image at a viewpoint sufficiently far from the object P. In this case, the processing portion 40 controls only the illumination portion 20. Also in this case, the processing portion 40 causes the first illumination light from the object P to be imaged. With such control, there is an advantage that a series of sequential operations, that is, illumination and imaging can be performed reliably and at a high speed.

That is, the processing portion 40 first causes the first object point P1 on the object surface P to be irradiated from the illumination portion 20 with light having the first wavelength spectrum as the first illumination light such that a light flux forms a first solid angle A1 at the first object point P1 on the object surface P (step S11). A solid angle not including the first solid angle A1 is set as a second solid angle (all solid angles other than the first solid angle A1) A2. Then, the processing portion 40 causes the imaging portion 30 to image the object P with the first illumination light and acquires a first captured image (step S21).

The processing portion 40 causes at least the first object point P1 on the object surface P to be irradiated with light having the first wavelength spectrum as second illumination light from the illumination portion 20. Furthermore, the processing portion 40 causes the imaging portion 30 to acquire an image at a viewpoint sufficiently far from the object P. That is, the processing portion 40 causes the object P to be imaged with the second illumination light.

That is, the processing portion 40 causes the first object point P1 to be irradiated with light having the first wavelength spectrum as the second illumination light such that light fluxes form a third solid angle A3 and a fourth solid angle A4 at the first object point P1 from the illumination portion 20 (step S11). The third solid angle A3 is included in the first solid angle A1. At the same time, the fourth solid angle A4 is included in the second solid angle A2. Here, it is assumed that the third solid angle A3 and the fourth solid angle A4 form a continuous region. However, the third solid angle A3 and the fourth solid angle A4 may not form the continuous region in this manner, and may form discontinuous regions. Then, the processing portion 40 causes the imaging portion 30 to image the object P with the second illumination light and acquires a second captured image (step S21). It is assumed that, in the cross section in FIG. 1, in order to simplify the description, the cross-sectional area of a region by the third solid angle A3 is half the cross-sectional area of a region by the first solid angle A1, and a region by the fourth solid angle A4 is included in a region by the second solid angle A2. The second solid angle A2 may be the entire solid angle that is not included in the first solid angle A1, or may be a solid angle less than the first solid angle A1. That is, the second solid angle A2 may be any solid angle that is not included in the first solid angle A1. However, the present embodiment is not limited thereto, and the second solid angle A2 and the fourth solid angle A4 may be the same, that is, may be common. It is assumed that the cross-sectional area of the region by the third solid angle A3 and the cross-sectional area of the region by the fourth solid angle A4 are the same.

The order of acquisition of the first captured image and the second captured image may be reversed. Therefore, the processing portion 40 can cause at least the first object point P1 of the object P to be irradiated with a light beam flux having the first wavelength spectrum at the first solid angle A1 as the first illumination light of the illumination portion 20, and can cause at least the first object point P1 to be irradiated with light beam fluxes having the first wavelength spectrum at the third solid angle A3 and the fourth solid angle A4 as the second illumination light of the illumination portion 20 before or after the irradiation with the light beam flux at the first solid angle A1. Therefore, the processing portion 40 may emit the first illumination light and the second illumination light at different times, and acquire the captured images.

For example, a case where the surface of the object P is smooth will be considered. In this case, light incident on the surface of the object P is specularly reflected. Here, it is assumed that the reflected light from the object point P on the surface of the object P travels along the imaging optical axis C₃₀ and is imaged by the imaging portion 30. That is, it is assumed that the direction of the last light beam acquired by the imaging portion 30 is along the imaging optical axis C₃₀. In this case, on the incident surface (cross section including the incident light), the incident angle of the light incident on the object point P1 and the inclination angle of the surface of the object P at the object point P1 have a one-to-one relationship. That is, if the incident angle is determined, the inclination angle is obtained, and if the inclination angle is determined, the incident angle is obtained. Therefore, the inclination angle converted from the incident angle is referred to as a converted inclination angle. A method of calculating the converted inclination angle may vary depending on the spatial arrangement of the illumination portion 20 and the imaging portion 30, but the one-to-one relationship between the incident angle and the inclination angle does not change. The calculation of the converted inclination angle is determined based on the configurations of the light source and the optical element used in the illumination portion 20, the configuration of the optical element used in the imaging portion 30, distances from the illumination portion 20 and the imaging portion 30 to the object P, and the like. However, even in a case where the surface of the object P is not smooth, a specularly reflected component (a specular reflection direction and an intensity distribution in the vicinity thereof) is generally strong in an angular distribution of reflected light in many cases. Then, the above-described one-to-one relationship is established for the specularly reflected component.

It is assumed that the first object point P1 appears in the first captured image. In this case, the inclination angle θ can be specified as being in a region (range) of a converted inclination angle converted from the first solid angle A1, and this region is set as a first converted inclination angle region. On the other hand, it is assumed that the first object point P1 does not appear in the first captured image. Then, it is found that the inclination angle θ is in a region (range) excluding the first converted inclination angle. This region is set as a second converted inclination angle region.

It is assumed that the first object point P1 appears in the first captured image and that the first object point P1 appears in the second captured image. In this case, the inclination angle θ can be specified as a region of a converted inclination angle converted from the third solid angle A3, and this region is set as a third converted inclination angle region. Since the third solid angle A3 is included in the first solid angle A1, the third converted inclination angle region is a region narrower than the first converted inclination angle region. The angle of the third converted inclination angle region at the first object point P1 is an estimated inclination angle. Therefore, the processing portion 40 acquires information regarding the inclination of the surface of the object P where the first object point P1 is present. That is, the processing portion 40 acquires information regarding the object P at the first object point P1 (step S3).

In addition, it is assumed that the first object point P1 appears in the first captured image and that the first object point P1 does not appear in the second captured image. In this case, the inclination angle can be specified as a region obtained by excluding a third inclination angle region from the first converted inclination angle region. This region is set as a third converted inclination angle complementary region. Since the third solid angle A3 is included in the first solid angle A1, the third converted inclination angle complementary region is a region narrower than the first converted inclination angle region. The angle of the third converted inclination angle complementary region at the first object point P1 is an estimated inclination angle. Therefore, the processing portion 40 acquires the information regarding the object P at the first object point P1 (step S3).

On the other hand, it is assumed that the first object point P1 does not appear in the first captured image and that the first object point P1 appears in the second captured image. In this case, the inclination angle θ can be specified as a region of a converted inclination angle converted from the fourth solid angle A4, and this region is set as a fourth converted inclination angle region. Since the fourth solid angle A4 is included in the second solid angle A2, the fourth converted inclination angle region is a region narrower than the second converted inclination angle region. The angle of the fourth converted inclination angle region at the first object point P1 is an estimated inclination angle. Therefore, the processing portion 40 acquires the information regarding the object P at the first object point P1 (step S3).

In addition, it is assumed that the first object point P1 does not appear in the first captured image and that the first object point P1 does not appear in the second captured image. In this case, the inclination angle can be specified as a region obtained by excluding a fourth inclination angle region from the second converted inclination angle region. This region is set as a fourth converted inclination angle complementary region. Since the fourth solid angle A4 is included in the second solid angle A2, the fourth converted inclination angle complementary region is a region narrower than the second converted inclination angle region. The angle of the fourth converted inclination angle complementary region at the first object point P1 is an estimated inclination angle. Therefore, the processing portion 40 acquires the information regarding the object P at the first object point P1 (step S3).

As described above, by using the first captured image and the second captured image in combination, the inclination angle θ at the first object point P1 is determined to be an estimated inclination angle of any one of the four inclination angle regions which are the third converted inclination angle region, the third converted inclination angle complementary region, the fourth converted inclination angle region, and the fourth converted inclination angle complementary region. Therefore, the processing portion 40 acquires information regarding the first object point P1 of the object P (step S3).

As step S3, an example of calculating the estimated inclination angle has been described. In step S3, in each loop that is not the last loop, only the converted inclination angle θ may be output. In this case, the estimated inclination angle may be calculated, for example, in step S3 of the last loop.

The inclination angle θ obtained only from the first captured image can take either the first converted inclination angle region or the second converted inclination angle region depending on whether or not the first object point P1 appears. The first converted inclination angle region is larger than the third converted inclination angle region or the third converted inclination angle complementary region. The second converted inclination angle region is larger than the fourth converted inclination angle region or the fourth converted inclination angle complementary region. As a result, it can be said that the accuracy of estimating the inclination angle θ (information regarding the object P) obtained by combining the first captured image and the second captured image is higher than the accuracy of estimating the inclination angle θ (information regarding the object P) obtained only from the first captured image.

On the other hand, the inclination angle θ obtained only from the second captured image can take either a region obtained by combining the third converted inclination angle region and the fourth converted inclination angle region or a region not including the combined region depending on whether or not the first object point P1 appears. The region obtained by combining the third converted inclination angle region and the fourth converted inclination angle region is larger than the third converted inclination angle region or the fourth converted inclination angle region. In addition, the region not including the region obtained by combining the third converted inclination angle region and the fourth converted inclination angle region is larger than the third inclination angle complementary region or the fourth inclination angle complementary region. As a result, it can be said that the accuracy of estimating the inclination angle θ (information regarding the object P) obtained by combining the first captured image and the second captured image is higher than the accuracy of estimating the inclination angle θ obtained only from the second captured image.

As described above, the optical inspection apparatus 10 according to the present embodiment has an effect of being capable of acquiring information (information regarding the object P) regarding the inclination angle θ of the object P in more detail by combining the first captured image and the second captured image. That is, by combining the first captured image and the second captured image as in the method (illustrated in FIG. 3) of the optical inspection apparatus 10 according to the present embodiment, a possible region (range) can be narrowed compared to the inclination angle θ obtained from only one of the captured images.

Note that i and n in FIG. 3 are natural numbers, n is greater than or equal to 2, and i is preferably a natural number less than or equal to n. As described above, there is an effect that the accuracy of estimating the inclination angle θ can be increased by recursively and repeatedly using the method of the optical inspection apparatus 10 according to the present embodiment. For example, after the second captured image is acquired, a fifth solid angle and a sixth solid angle are further formed with respect to the third solid angle A3 so as to have a relationship similar to the relationship between the third solid angle A3 and the fourth solid angle A4 with respect to the first solid angle A1, a seventh solid angle and an eighth solid angle are further formed with respect to the fourth solid angle A4 so as to have a relationship similar to the relationship between the third solid angle A3 and the fourth solid angle A4 with respect to the first solid angle A1, and third illumination light (light having the first wavelength spectrum) is emitted at the fifth solid angle, the sixth solid angle, the seventh solid angle, and the eighth solid angle, and a third captured image may be acquired using the imaging portion 30 based on illumination with the third illumination light.

Furthermore, a ninth solid angle and a tenth solid angle with respect to the fifth solid angle, and an eleventh solid angle and a twelfth solid angle with respect to the sixth solid angle are formed so as to have a relationship similar to the relationship between the third solid angle A3 and the fourth solid angle A4 with respect to the first solid angle A1, a thirteenth solid angle and a fourteenth solid angle with respect to the eighth solid angle, and a fifteenth solid angle and a sixteenth solid angle with respect to the ninth solid angle are formed so as to have a relationship similar to the relationship between the third solid angle A3 and the fourth solid angle A4 with respect to the first solid angle A1, and fourth illumination light (light having the first wavelength spectrum) is emitted at the ninth to sixteenth solid angles, and a fourth captured image may be acquired using the imaging portion 30 based on illumination with the fourth illumination light.

The optical inspection apparatus 10 according to the present embodiment can obtain more captured images while finely dividing the solid angle, and obtain the information regarding the object by these captured images. As described above, the optical inspection apparatus 10 according to the present embodiment can exponentially increase the number of solid angles within a predetermined range (a range obtained by combining the region of the first solid angle A1 and the region of the second solid angle A2 in FIG. 1), and the processing portion 40 obtains a captured image accordingly, and determines whether or not the object point P1 appears in the captured image, and thus the accuracy of estimating the inclination angle θ can be improved. In the optical inspection apparatus 10 according to the present embodiment, only the first wavelength spectrum, that is, the white light is used. Even if only one color is used in this manner, there is an effect that the accuracy of acquiring the information regarding the object P can be improved by using the optical inspection apparatus 10 according to the present embodiment inductively (or repeatedly).

For example, in a case where the cross-sectional area formed in a fan shape having the same radius around the first object point P1 by the third solid angle A3 is ½ of the cross-sectional area formed in a fan shape around the first object point P1 by the first solid angle A1 in the cross section illustrated in FIG. 1, and similarly, the fan-shaped cross-sectional areas formed by the third solid angle A3 and the fourth solid angle A4 (second solid angle A2) are the same, the accuracy of the inclination angle θ that can be estimated by the processing portion 40 from the first captured image and the second captured image is, for example, twice the accuracy in a case where only the first captured image is obtained. Here, the double accuracy means that the range that can be taken by the estimated inclination angle is halved. Furthermore, as described above, in the present embodiment, the accuracy of the inclination angle θ that can be estimated by further using the third captured image obtained by forming the fifth solid angle, the sixth solid angle, the seventh solid angle, and the eighth solid angle is four times the accuracy of a case where only the first captured image is obtained. Furthermore, the accuracy of the inclination angle θ that can be estimated by further using the fourth captured image obtained by forming the solid angles is 16 times the accuracy of a case where only the first captured image is obtained. As described above, the optical inspection apparatus 10 according to the present embodiment can more accurately obtain an inclination angle θ of a target object point by making a corresponding solid angle narrower and obtaining a corresponding captured image.

The range of the first wavelength spectrum that is the illumination light used in the present embodiment may be appropriately wide or may be narrower than that of white light, for example. An example of a case where the wavelength region of the first wavelength spectrum is narrow is a case where a single color such as blue, red, or green is used and can be set as appropriate.

In the present embodiment, after the light beam flux at the first solid angle A1 is formed by the illumination portion 20, the light beam fluxes at the third solid angle A3 and the light beam flux at the fourth solid angle A4 are simultaneously formed. On the other hand, a case where only one of light beam fluxes at the third solid angle A3 and the fourth solid angle A4 is formed will be considered.

For example, a case where only the light beam flux at the third solid angle A3 is formed will be considered. In this case, if the first captured image and the second captured image are used in combination, the processing portion 40 determines that the inclination angle θ at the first object point P1 is one of the three inclination angle regions which are the second converted inclination angle region, the third converted inclination angle region, and the third converted inclination angle complementary region. Here, the second converted inclination angle region is larger than the fourth converted inclination angle region or the fourth converted inclination angle complementary region. That is, in this case, the range that can be taken by the inclination angle θ is wider than a case where the optical inspection apparatus 10 according to the present embodiment is used. In other words, it can be said that the accuracy of estimating the inclination angle θ is lower than a case where the optical inspection apparatus 10 according to the present embodiment is used.

For example, a case where only the light beam flux at the fourth solid angle A4 is formed will be considered. In this case, if the first captured image and the second captured image are used in combination, the processing portion 40 determines that the inclination angle θ at the first object point P1 is one of the three inclination angle regions which are the first converted inclination angle region, the fourth converted inclination angle region, and the fourth converted inclination angle complementary region. Here, the first converted inclination angle region is larger than the third converted inclination angle region or the third converted inclination angle complementary region. That is, in this case, the range that can be taken by the inclination angle θ is wider than a case where the optical inspection apparatus 10 according to the present embodiment is used. In other words, it can be said that the accuracy of estimating the inclination angle θ is lower than a case where the optical inspection apparatus 10 according to the present embodiment is used.

As described above, as in the optical inspection apparatus 10 according to the present embodiment, the solid angle included in the first solid angle A1 is set as the third solid angle A3, the solid angle included in the second solid angle A2 is set as the fourth solid angle A4, and the light beam fluxes at the third solid angle A3 and the fourth solid angle A4 are simultaneously formed by the illumination portion 20, so that there is an effect that the accuracy of estimating the inclination angle θ can be improved.

A direction distribution of light reflected from the surface of the object P changes according to the surface property and the surface shape of the object P. The direction distribution of the reflected light is referred to as a bidirectional reflectance distribution function (BRDF). In general, the surface property and the surface shape of the surface of the object P, that is, the information regarding the object surface P can be estimated based on the BRDF. In a case where the surface of the object P is smooth, light incident on the surface is specularly reflected. In this case, the BRDF indicates that there is only one specular reflection direction relative to one incident direction. That is, for example, if the specular reflection direction is determined to be parallel to the imaging optical axis C₃₀, it can be said that the inclination angle θ of the surface of the object P and the incident angle have a one-to-one relationship. On the other hand, in a case where the surface of the object P is a rough surface, light incident on the surface is scattered. In this case, a diffuse component other than a specularly reflected component is also generated at the same time. However, the specularly reflected component generally has a light intensity larger than that of the diffuse component in many cases.

In the above description, as an example, a case where the object surface P is smooth and regularly reflects light has been considered. However, in the present embodiment, the object surface P is not limited thereto, and the object surface P may be a rough surface. In this case, it is assumed that the specularly reflected component has a higher light intensity than that of the diffuse component. In the above discussion, the processing portion 40 makes a distinction by determining whether or not the first object point P1 appears in the captured image when the first object point P1 is imaged, but the processing portion 40 may make a distinction by determining whether the intensity of light from the first object point P1 is high or low. For example, the processing portion 40 can use a difference in light intensity between white and black light received by the imaging portion 30. By making such distinction, the processing portion 40 can obtain a similar result even in a case where the object surface P is a rough surface. That is, the processing portion 40 can improve the accuracy of estimating the inclination angle θ of the object surface P by combining the first captured image and the second captured image and comparing the magnitudes of the light intensities of the captured images of the first object point P1. Therefore, in the optical inspection apparatus 10 according to the present embodiment, there is an effect that information regarding the shape of the object surface P having various BRDFs can be acquired. Of course, the processing portion 40 may estimate the inclination angle θ of the object surface P as the information regarding the object P by combining the first captured image and the second captured image, comparing the magnitudes of the light intensities of the captured images of the first object point P1, and determining whether or not the first object point P1 appears.

In the present embodiment, the example of acquiring the information regarding the object P using the surface of the object P as an example has been described. For example, it is also possible to acquire information regarding not the surface but the inner surface of the object P.

Therefore, the optical inspection apparatus 10 according to the present embodiment includes the illumination portion 20, the imaging portion 30, and the processing portion 40. The illumination portion 20 is configured to irradiate at least the first object point P1 of the object P with light beam fluxes at a plurality of solid angles. Here, the plurality of solid angles include one solid angle. The imaging portion 30 is configured to acquire an image of the object P according to illumination with a light beam flux at one or a plurality of solid angles. The processing portion 40 causes the first object point P1 of the object P to be irradiated with the light beam flux at the first solid angle A1 by the first illumination light from the illumination portion 20, is configured to set the solid angle not including the first solid angle A1 as the second solid angle A2, is configured to acquire the first captured image of the object P using the imaging portion 30 based on illumination with the first illumination light, is configured to set the solid angle included in the first solid angle A1 as the third solid angle A3, is configured to set the solid angle included in the second solid angle A2 as the fourth solid angle A4, causes at least the first object point P1 to be irradiated with light beam fluxes at the third solid angle A3 and the fourth solid angle A4 by the second illumination light from the illumination portion 20, is configured to acquire the second captured image of the object P using the imaging portion 30 based on illumination with the second illumination light, and is configured to acquire the information regarding the object P based on the first captured image and the second captured image.

Furthermore, the optical inspection method according to the present embodiment includes: irradiating at least the first object point P1 of the object P with the light beam flux at the first solid angle A1 by the first illumination light from the illumination portion 20, the solid angle not including the first solid angle A1 being set as the second solid angle A2; acquiring the first captured image of the object P using the imaging portion 30 based on illumination with the first illumination light; setting the solid angle included in the first solid angle A1 as the third solid angle A3, setting the solid angle included in the second solid angle A2 as the fourth solid angle A4, and irradiating at least the first object point P1 with the light beam fluxes at the third solid angle A3 and the fourth solid angle A4 by the second illumination light from the illumination portion 20; acquiring the second captured image of the object P using the imaging portion 30 based on illumination with the second illumination light; and acquiring the information regarding the object P based on the first captured image and the second captured image.

In addition, the optical inspection program according to the present embodiment causes a computer to execute: causing at least the first object point of the object to be irradiated with the light beam flux at the first solid angle by the first illumination light from the illumination portion 20, setting the solid angle not including the first solid angle as the second solid angle; acquiring the first captured image of the object P using the imaging portion 30 based on illumination with the first illumination light; setting the solid angle included in the first solid angle A1 as the third solid angle A3, setting the solid angle included in the second solid angle A2 as the fourth solid angle A4, and causing at least the first object point P1 to be irradiated with the light beam fluxes at the third solid angle A3 and the fourth solid angle A4 by the second illumination light from the illumination portion 20; acquiring the second captured image of the object P using the imaging portion 30 based on illumination with the second illumination light; and acquiring the information regarding the object P based on the first captured image and the second captured image.

Therefore, according to the present embodiment, it is possible to provide an optical inspection apparatus, an optical inspection method, and a non-transitory storage medium storing an optical inspection program, which are capable of acquiring information regarding an object with illumination of a small number of colors (wavelength spectrum).

In the present embodiment, for example, the description has been given assuming that light having the first wavelength spectrum is emitted for the first illumination light to the fourth illumination light. For example, the wavelength spectra of the third illumination light and the fourth illumination light may be different from the first wavelength spectrum of the first illumination light and the second illumination light.

### (Modification 1)

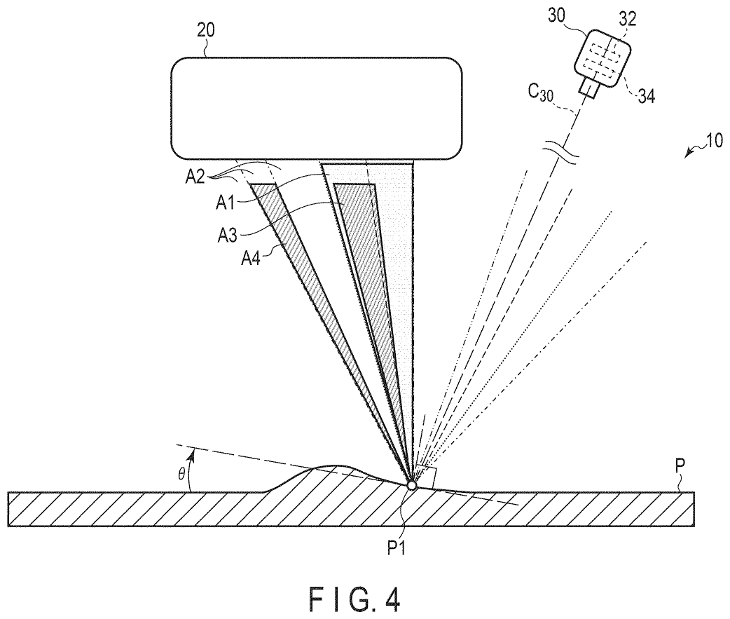

In the first embodiment described above, the third solid angle A3 and the fourth solid angle A4 form the continuous region (overlapped). As illustrated in FIG. 4, the third solid angle A3 and the fourth solid angle A4 may be separated from each other.

Also in this case, the third solid angle A3 is included in the first solid angle A1. The fourth solid angle A4 is included in the second solid angle A2.

Then, the processing portion 40 can estimate the inclination angle θ of the object surface P as the information regarding the object P by combining the first captured image and the second captured image, and, for example, determining whether or not the first object point P1 appears.

### (Modification 2)

In the present modification, it is assumed that a color image sensor is used as the image sensor 32. In addition, it is assumed that the first illumination light includes light having the first wavelength spectrum and that the second illumination light includes light having the second wavelength spectrum. It is assumed that the light having the first wavelength spectrum and the light having the second wavelength spectrum are not similar to each other and have the different wavelength spectra.

In the example of the first embodiment described above, the processing portion 40 causes the illumination portion 20 to emit a light beam flux having the first wavelength spectrum at the first solid angle A1 and then emit light beam fluxes having the first wavelength spectrum at the third solid angle A3 and the fourth solid angle A4.

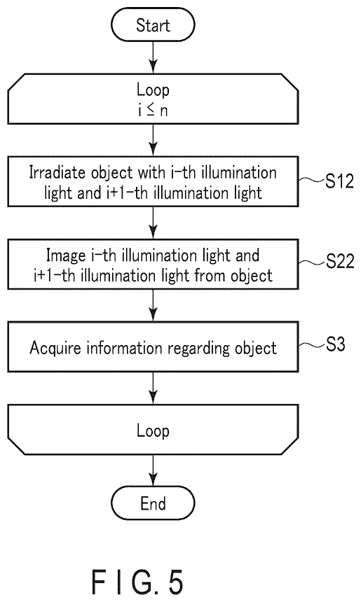

Processing in Modification 2 will be briefly described with reference to a procedure illustrated in FIG. 5.

As illustrated in FIG. 5, the processing portion 40 causes at least the first object point P1 on the object surface P to be irradiated with a light beam flux having the first wavelength spectrum at the first solid angle A1 from the illumination portion 20 and to be simultaneously irradiated with light beam fluxes having the second wavelength spectrum at the third solid angle A3 and the fourth solid angle A4 (step S12). Then, the processing portion 40 further causes the imaging portion 30 including the color image sensor 32 to distinguish the first wavelength spectrum and the second wavelength spectrum in at least two different color channels of the color image sensor 32, and acquire captured images of the first and second wavelength spectra as the first captured image and the second captured image (step S22). In this way, it is possible to obtain a plurality of captured images at a higher speed than that in a case where the captured images are obtained in order such as the order of the first captured image, the second captured image, . . . by irradiation with illumination light having the same wavelength. Therefore, according to the optical inspection apparatus 10 according to Modification 2, there is an effect that the information regarding the object P can be acquired at a higher speed.

The solid angle included in the first solid angle A1 is set as the third solid angle A3, the solid angle included in the second solid angle A2 is set as the fourth solid angle A4, and the illumination portion 20 simultaneously forms a light beam flux having the first wavelength spectrum at the first solid angle A1 and light beam fluxes having the second wavelength spectrum at the third solid angle A3 and the fourth solid angle A4, so that there is an effect that the accuracy of estimating the inclination angle θ can be improved. Here, the third solid angle A3 and the fourth solid angle A4 may form a continuous region. Alternatively, the third solid angle A3 and the fourth solid angle A4 may form discontinuous independent regions.

Furthermore, similarly to the description of the processing illustrated in FIG. 3, in the optical inspection apparatus 10 according to the Modification 2, there is an effect that the accuracy of estimating the inclination angle θ can be increased by recursively and repeatedly using the present method. For example, after the processing portion 40 acquires the first captured image and the second captured image, the processing portion 40 may form light beam fluxes having the first wavelength spectrum at the fifth solid angle and the sixth solid angle with respect to the third solid angle A3 similarly to the third solid angle A3 and the fourth solid angle A4 with respect to the first solid angle A1. Similarly to the third solid angle A3 and the fourth solid angle A4 with respect to the first solid angle A1, the processing portion 40 may form light beam fluxes having the first wavelength spectrum at the seventh solid angle and the eighth solid angle with respect to the fourth solid angle A4. Then, the processing portion 40 causes at least the first object point P1 on the object surface P to be irradiated with the first illumination light having the first wavelength spectrum at the fifth solid angle, the sixth elevation angle, the seventh solid angle, and the eighth solid angle, and the processing portion 40 may acquire the third captured image using the imaging portion 30 based on illumination with the first illumination light. This makes it possible to exponentially increase the number of solid angles and accordingly improve the accuracy of estimating the inclination angle θ. In the Modification 2, the first wavelength spectrum and the second wavelength spectrum, that is, only two colors are used. Even if only two colors are used in this manner, there is an effect that the accuracy of acquiring the information regarding the object P can be improved by using the Modification 2 inductively (or repeatedly).

Although the description is omitted, the processing portion 40 may estimate the information (inclination angle θ) regarding the object P by using illumination light having three or more different wavelength spectra as long as the imaging portion 30 can acquire images as different captured images.

In the Modification 2, for example, light having the first wavelength spectrum is emitted as the first illumination light, and light having the second wavelength spectrum is emitted as the second illumination light. For example, the wavelength spectra of the third illumination light and the fourth illumination light may be the same as the wavelength spectra of the first illumination light and the second illumination light, respectively, but may be different for both light having the first wavelength spectrum and light having the second wavelength spectrum.

### Second Embodiment

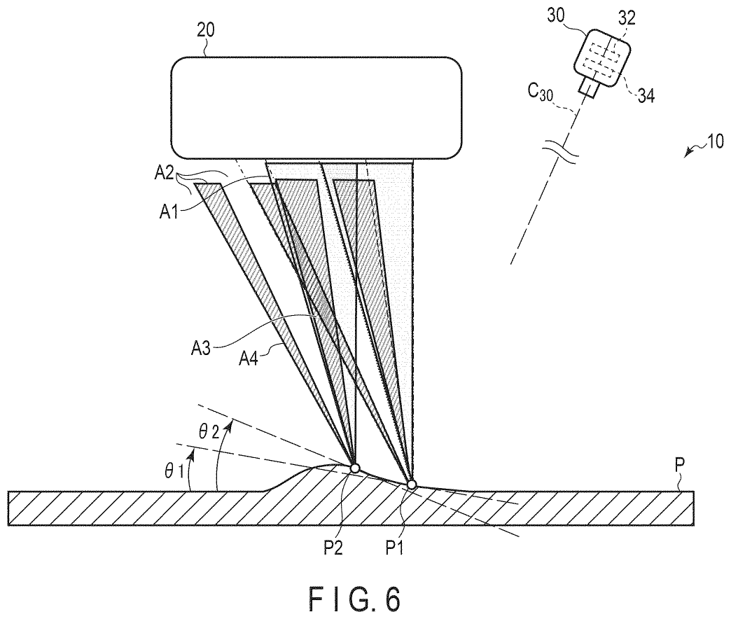

An optical inspection apparatus according to the present embodiment will be described below with reference to FIG. 6. The present embodiment is a further modification of the first embodiment including each modification, and the same members as the members described in the first embodiment or members having the same functions as the members described in the first embodiment are denoted by the same reference numerals as much as possible, and a detailed description thereof will be omitted.

FIG. 6 is a schematic cross-sectional view of the optical inspection apparatus 10 according to the present embodiment.

An operation of the optical inspection apparatus 10 according to the present embodiment will be described.

The processing portion 40 causes at least the first object point P1 and the second object point P2 on the object surface P to be simultaneously irradiated with light having the first wavelength spectrum by the illumination portion 20 (step S12). Furthermore, the processing portion 40 causes the imaging portion 30 to acquire an image at a viewpoint sufficiently far from the object P (step S22). In this case, a light beam acquired by the imaging portion 30 can be regarded as being substantially parallel to the imaging optical axis C₃₀.

In step S12 in the processing procedure illustrated in FIG. 5, the processing portion 40 causes the first object point P1 and the second object point P2 on the object surface P to be irradiated with light having the first wavelength spectrum as the first illumination light such that light fluxes form the first solid angle A1 at the first object point P1 and the second object point P2 on the object surface P from the illumination portion 20. A solid angle not including the first solid angle A1 is set as the second solid angle A2. Furthermore, the processing portion 40 causes the first object point P1 and the second object point P2 on the object surface P to be irradiated with light having the second wavelength spectrum as the second illumination light such that light fluxes form the third solid angle A3 and the fourth solid angle A4 at the first object point P1 and the second object point P2 from the illumination portion 20. The third solid angle A3 is included in the first solid angle A1. At the same time, the fourth solid angle A4 is included in the second solid angle A2.

For example, a case where the surface of the object P is smooth will be considered. In this case, light incident on the surface of the object P is specularly reflected. Here, it is assumed that the light reflected from the object point P on the surface of the object P travels along the imaging optical axis C₃₀ and is imaged by the imaging portion 30 (step S22). Then, the incident angle of the light incident on the object point and the inclination angle θ of the object surface P at the object point have a one-to-one relationship. That is, if the incident angle is determined, the inclination angle θ is obtained, and if the inclination angle θ is determined, the incident angle is obtained. Therefore, the inclination angle θ converted from the incident angle is referred to as a converted inclination angle. However, even in a case where the surface of the object P is not smooth, a specularly reflected component in an angular distribution of reflected light is generally strong in many cases. Then, the above-described one-to-one relationship is established for the specularly reflected component.

The first object point P1 is similar to that in the first embodiment, and the processing portion 40 can acquire the information regarding the object P at the first object point P1 by combining the first captured image and the second captured image (step S3).

The second object point P2 will be described below.

In addition to the first object point P1 on the object surface P, the processing portion 40 causes the second object point P2 on the object surface P to be irradiated with light having the first wavelength spectrum as the first illumination light from the illumination portion 20 such that a light flux forms the first solid angle A1 at the second object point P2 (step S12). A solid angle not including the first solid angle A1 is set as the second solid angle A2. Then, the processing portion 40 causes the imaging portion 30 to capture the first illumination light corresponding to the light having the first wavelength spectrum from the object P, and acquires a first captured image (step S22).

The processing portion 40 causes the second object point P2 to be irradiated with light having the second wavelength spectrum as the second illumination light such that light fluxes form the third solid angle A3 and the fourth solid angle A4 at the second object point P2 and to be simultaneously irradiated with the first illumination light (step S12). The third solid angle A3 is included in the first solid angle A1. At the same time, the fourth solid angle A4 is included in the second solid angle A2. Here, it is assumed that the third solid angle A3 and the fourth solid angle A4 form discontinuous regions. However, the third solid angle A3 and the fourth solid angle A4 may not form the discontinuous regions as described above, and may form a continuous region. Then, the processing portion 40 causes the imaging portion 30 to capture the second illumination light from the object P and acquires a second captured image (step S22).

The processing portion 40 can cause the object P to be simultaneously irradiated with the light having the first wavelength spectrum of the first illumination light and the light having the second wavelength spectrum of the second illumination light, and the processing portion 40 can cause the imaging portion 30 to simultaneously separate and receive the first captured image corresponding to the light having the first wavelength spectrum of the first illumination light and the second captured image corresponding to the light having the second wavelength spectrum of the second illumination light.

It is assumed that the second object point P2 appears in the first captured image. In this case, the inclination angle θ can be specified as being in a region (range) of a converted inclination angle converted from the first solid angle A1, and this region is set as a first converted inclination angle region. On the other hand, it is assumed that the second object point P2 does not appear in the first captured image. Then, it is found that the inclination angle θ is an estimated inclination angle of a region excluding the first converted inclination angle. A region including the estimated inclination angle at the second object point P2 is set as a second converted inclination angle region. Therefore, the processing portion 40 acquires information regarding the object P at the second object point P2 (step S3).

It is assumed that the second object point P2 appears in the first captured image and that the second object point P2 appears in the second captured image. In this case, the inclination angle can be specified as a region of a converted inclination angle converted from the third solid angle A3, and this region is set as a third converted inclination angle region. The third converted inclination angle region is a region narrower than the first converted inclination angle region. The angle of the third converted inclination angle region at the second object point P2 is an estimated inclination angle. Therefore, the processing portion 40 acquires information regarding the object P at the second object point P2 (step S3).

In addition, it is assumed that the second object point P2 appears in the first captured image and that the second object point P2 does not appear in the second captured image. In this case, an inclination angle θ2 at the second object point P2 can be specified as the region obtained by excluding the third inclination angle region from the first converted inclination angle region. This region is set as a third converted inclination angle complementary region. The third converted inclination angle complementary region is a region narrower than the first converted inclination angle region. The angle of the third converted inclination angle complementary region at the second object point P2 is an estimated inclination angle. Therefore, the processing portion 40 acquires information regarding the object P at the second object point P2 (step S3).

On the other hand, it is assumed that the second object point P2 does not appear in the first captured image and that the second object point P2 appears in the second captured image. In this case, the inclination angle θ at the second object point P2 can be specified as a region of a converted inclination angle converted from the fourth solid angle A4, and this region is set as the fourth converted inclination angle region. The fourth converted inclination angle region is a region narrower than the second converted inclination angle region. The angle of the fourth converted inclination angle region at the second object point P2 is an estimated inclination angle. Therefore, the processing portion 40 acquires information regarding the object P at the second object point P2 (step S3).

In addition, it is assumed that the second object point P2 does not appear in the first captured image and that the second object point P2 does not appear in the second captured image. In this case, an inclination angle region θ2 at the second object point P2 can be specified as a region obtained by excluding the fourth inclination angle region from the second converted inclination angle region. This region is set as a fourth converted inclination angle complementary region. The fourth converted inclination angle complementary region is a region narrower than the second converted inclination angle region. The angle of the fourth converted inclination angle complementary region at the second object point P2 is an estimated inclination angle. Therefore, the processing portion 40 acquires information regarding the object P at the second object point P2 (step S3).

As described above, by using the first captured image and the second captured image in combination, the processing portion 40 determines that the inclination angle θ2 at the second object point P2 is an estimated inclination angle of any one of the four inclination angle regions which are the third converted inclination angle region, the third converted inclination angle complementary region, the fourth converted inclination angle region, and the fourth converted inclination angle complementary region.

As step S3, an example has described that the processing portion 40 calculates the estimated inclination angle. In step S3, the processing portion 40 may only output the converted inclination angle θ in each loop that is not the last loop. In this case, the processing portion 40 may calculate the estimated inclination angle, for example, in step S3 of the last loop.

The inclination angle θ2 obtained only from the first captured image can take either the first converted inclination angle region or the second converted inclination angle region depending on whether or not the second object point P2 appears. The first converted inclination angle region is larger than the third converted inclination angle region or the third converted inclination angle complementary region. The second converted inclination angle region is larger than the fourth converted inclination angle region or the fourth converted inclination angle complementary region. As a result, it can be said that the accuracy of estimating the inclination angle θ2 (information regarding the object P) obtained by combining the first captured image and the second captured image is higher than the accuracy of estimating the inclination angle θ2 (information regarding the object P) obtained only from the first captured image.

On the other hand, the inclination angle θ2 obtained only from the second captured image can take either a region obtained by combining the third converted inclination angle region and the fourth converted inclination angle region or a region not including the combined region depending on whether or not the second object point P2 appears. The region obtained by combining the third converted inclination angle region and the fourth converted inclination angle region is larger than the third converted inclination angle region or the fourth converted inclination angle region. In addition, the region not including the region obtained by combining the third converted inclination angle region and the fourth converted inclination angle region is larger than the third inclination angle complementary region or the fourth inclination angle complementary region. As a result, it can be said that the accuracy of estimating the inclination angle θ2 (information regarding the object P) obtained by combining the first captured image and the second captured image is higher than the accuracy of estimating the inclination angle θ2 (information regarding the object P) obtained only from the second captured image.

As described above, there is an effect that the processing portion 40 can acquire information regarding the inclination angle θ2 at the object point P2 of the object P in more detail by combining the first captured image and the second captured image. That is, as in the present embodiment, the solid angle included in the first solid angle A1 is set as the third solid angle A3, the solid angle included in the second solid angle A2 is set as the fourth solid angle A4, and light beam fluxes at the third solid angle A3 and the fourth solid angle A4 are simultaneously formed by the illumination portion 20, so that there is an effect that the accuracy of estimating the inclination angle θ2 can be improved. As described above, there is an effect that the accuracy of estimating the inclination angle θ2 can be increased by recursively and repeatedly using the method of the optical inspection apparatus 10 according to the present embodiment.

In the above description, as an example, a case where the object surface P is smooth and regularly reflects light has been considered. However, in the present embodiment, the object surface P is not limited thereto, and the object surface P may be a rough surface. In this case, it is assumed that the specularly reflected component has a higher light intensity than that of the diffuse component. Then, the processing portion 40 makes a distinction by determining whether or not the second object point P2 appears in the captured images when the second object point P2 is imaged. However, the processing portion 40 may make a distinction by determining whether an intensity (pixel value) of light from the second object point P2 is high or low. Therefore, even in a case where the object surface P is a rough surface, the processing portion 40 can obtain a similar result by comparing the magnitudes of light intensities of captured images of the second object point P2 instead. That is, the processing portion 40 can improve the accuracy of estimating the inclination angle θ2 of the object surface P by combining the first captured image and the second captured image and comparing the magnitudes of the light intensities of the captured images of the second object point P2. Therefore, according to the present embodiment, there is an effect that information regarding the shape of the object surface P having various BRDFs can be acquired. Of course, the processing portion 40 may estimate the inclination angle θ of the object surface P as the information regarding the object P by combining the first captured image and the second captured image, comparing the magnitudes of the light intensities of the captured images of the second object point P2, and determining whether or not the second object point P2 appears.

Furthermore, according to the present embodiment, the processing portion 40 can simultaneously acquire not only the information regarding the object P at the first object point but also the information regarding the object P at the second object point. That is, the processing portion 40 can detect whether the state (shape and property) of the second object point is different from that of the first object point. For example, the processing portion 40 can distinguish a difference in inclination of the surface between the first object point and the second object point. Alternatively, the processing portion 40 can distinguish a difference in BRDF between the first object point and the second object point. For example, in a case where a standard surface is a flat surface, the first object point is on the flat surface, and the second object point is on the flat surface but has a minute defect, the BRDFs of the object points are different from each other. Therefore, the processing portion 40 can detect that the second object point is different from the standard surface based on a difference in intensity of light reflected from both the object points or a difference in wavelength spectrum. That is, the processing portion 40 can detect the presence or absence of the minute defect.

Therefore, according to the present embodiment, it is possible to provide an optical inspection apparatus 10, an optical inspection method, and a non-transitory storage medium storing an optical inspection program, which are capable of acquiring the information regarding the object P with illumination of a small number of colors (wavelength spectrum).

### Third Embodiment

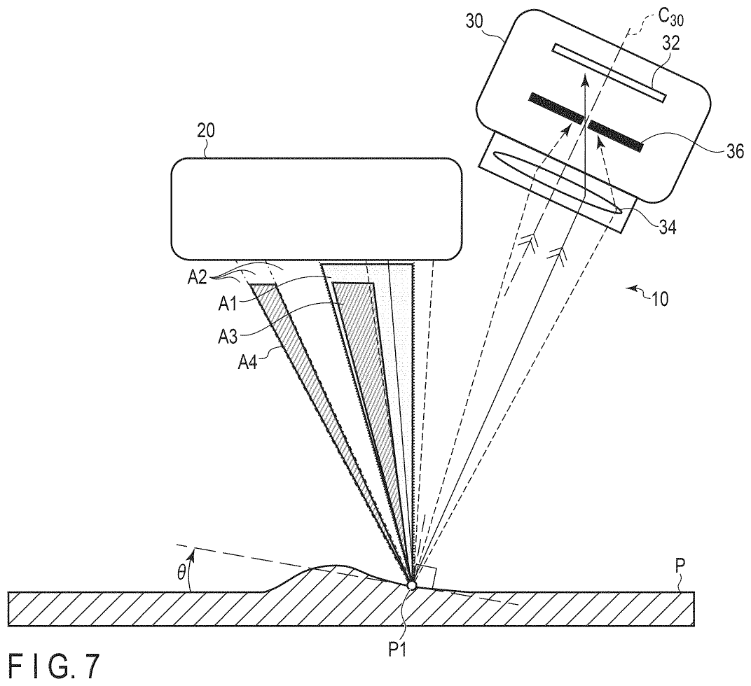

An optical inspection apparatus 10 according to the present embodiment will be described below with reference to FIG. 7. A basic configuration of the present embodiment is the same as that of the optical inspection apparatus 10 according to the first embodiment. Therefore, in the present embodiment, only differences will be described.

FIG. 7 is a schematic cross-sectional view of the optical inspection apparatus 10 according to the present embodiment. The cross-sectional view illustrated in FIG. 7 includes the imaging optical axis C₃₀ of the imaging portion 30.

The imaging portion 30 uses an image sensor 32 and an imaging optical element 34, and can form an image of light on the image sensor 32 by the imaging optical element 34. In the present embodiment, it is assumed that the imaging optical element 34 is an assembled lens. The imaging optical element 34 of the imaging portion 30 is referred to as an imaging optical element for imaging.

The imaging portion 30 includes a first light selection portion 36 on the focal plane f₃₀ of the imaging optical element 34 for imaging. The light selection portion 36 selectively allows light to pass through the light selection portion 36 or changes a property of the light according to a position where the light reached. The light selection portion 36 may be, for example, a diaphragm. In the present embodiment, the light selection portion 36 is a diaphragm having a through-hole on the imaging optical axis C₃₀. That is, the light selection portion 36 allows only light that reached the optical axis C₃₀ to pass through the light selection portion 36, and shields other light. However, the present embodiment is not limited thereto, and the light selection portion 36 may change the intensity of the light immediately after the passage or may change the direction of the light according to the position where the light reached. For example, the light selection portion 36 may change the light intensity immediately after the passage according to the polarization state of the light at the arrival position of the light on the light selection portion 36, or may change the light intensity according to a wavelength of the light. The light selection portion 36 may be, for example, a wavelength filter having a plurality of regions that transmit different wavelength spectra. That is, for example, the light selection portion 36 may transmit light having the first wavelength spectrum that reached the optical axis C₃₀ of the light selection portion 36, and may shield light having a wavelength spectrum different from the first wavelength spectrum. Then, the light selection portion 36 may shield light having the first wavelength spectrum that reached a region far from the optical axis C₃₀. Alternatively, the light selection portion 36 may transmit light that reached the optical axis C₃₀ of the light selection portion 36 and has a wavelength spectrum different from the first wavelength spectrum, and may shield light having the first wavelength spectrum. Alternatively, the light selection portion 36 may be a diffusion plate. In this case, by providing the through-hole on the optical axis C₃₀ of the diffusion plate, only a light beam passing through the through-hole passes through the diffusion plate while maintaining a light beam direction. Therefore, the light beam that passed in this manner can form an image on the image sensor 32. On the other hand, the direction of a light beam which reached a region surrounding the through-hole is changed by the diffusion plate. Therefore, an image of the object P cannot be formed on the image sensor 32. That is, only the light beam passing through the through-hole is imaged (image capturing).

An operation of the optical inspection apparatus 10 according to the present embodiment will be described based on the above-described configuration.

The processing portion 40 causes at least the first object point P1 on the object surface P to be irradiated with light having the first wavelength spectrum as the first illumination light from the illumination portion 20.

Since the diaphragm 36 is disposed on the focal plane f₃₀ of the imaging optical element 34 for imaging, only a light beam acquired by the image sensor 32 of the imaging portion 30 and parallel to the imaging optical axis C₃₀ is imaged. That is, a light beam traveling obliquely with respect to the imaging optical axis C₃₀ is shielded by the diaphragm 36. In this case, the imaging portion 30 has telecentricity on the object side. As a result, even in a case where the imaging portion 30 is brought close to the object P, the relationship between the inclination angle θ of the smooth object surface P and the incident angle of light is a one-to-one relationship.

The same applies to a case where at least the first object point P1 on the object surface P is irradiated with light having the first wavelength spectrum as the second illumination light.

As a result, the processing portion 40 can acquire the information regarding the inclination angle θ of the object P in more detail by combining the first captured image and the second captured image. That is, as in the present embodiment, the processing portion 40 simultaneously forms the solid angle included in the first solid angle A1 that is set as the third solid angle A3, the solid angle included in the second solid angle A2 that is set as the fourth solid angle A4, and causes the the object surface P to be simultaneously irradiated with light beam fluxes at the third solid angle A3 and the fourth solid angle A4 from the illumination portion 20, so that there is an effect that the accuracy of estimating the inclination angle θ can be improved. As described above, there is an effect that the accuracy of estimating the inclination angle θ can be increased by recursively and repeatedly using the method of the optical inspection apparatus 10 according to the present embodiment.

Therefore, according to the present embodiment, it is possible to provide an optical inspection apparatus 10, an optical inspection method, and a non-transitory storage medium storing an optical inspection program, which are capable of acquiring the information regarding the object P with illumination of a small number of colors (wavelength spectrum).

### (Modification)

As the first light selection portion 36 according to the present Modification, a wavelength filter having a region that selectively transmits two different wavelength spectra is used instead of the diaphragm. That is, it is assumed that the first light selection portion 36 according to the Modification includes a region that is centered on the optical axis C₃₀ of the light selection portion 36 and transmits light having the first wavelength spectrum that reached the vicinity of the center, and a region that surrounds the region centered on the optical axis C₃₀ and shields light having the first wavelength spectrum and transmits light having the second wavelength spectrum different from the first wavelength spectrum. Since the first light selection portion 36 is formed in this manner, the light having the first wavelength spectrum becomes light having a wavelength spectrum different from the original one if passing through the surrounding region of the first light selection portion 36. Then, even an oblique light beam other than a light beam parallel to the imaging optical axis C₃₀ can be imaged by the imaging portion 30 including the color image sensor 32 acquiring a captured image. By distinguishing between the first wavelength spectrum and a spectrum different from the first wavelength spectrum, the processing portion 40 can acquire at least information regarding the object P similar to that in a case where the light selection portion 36 is a diaphragm. Furthermore, since the processing portion 40 can acquire the light beam oblique to the imaging optical axis C₃₀, there is an effect that more detailed information regarding the object P can be acquired. This means that more detailed BRDF information can be acquired. The fact that the detailed BRDF information can be acquired means that information regarding the shape and property of the surface of the object can be acquired.

### Fourth Embodiment

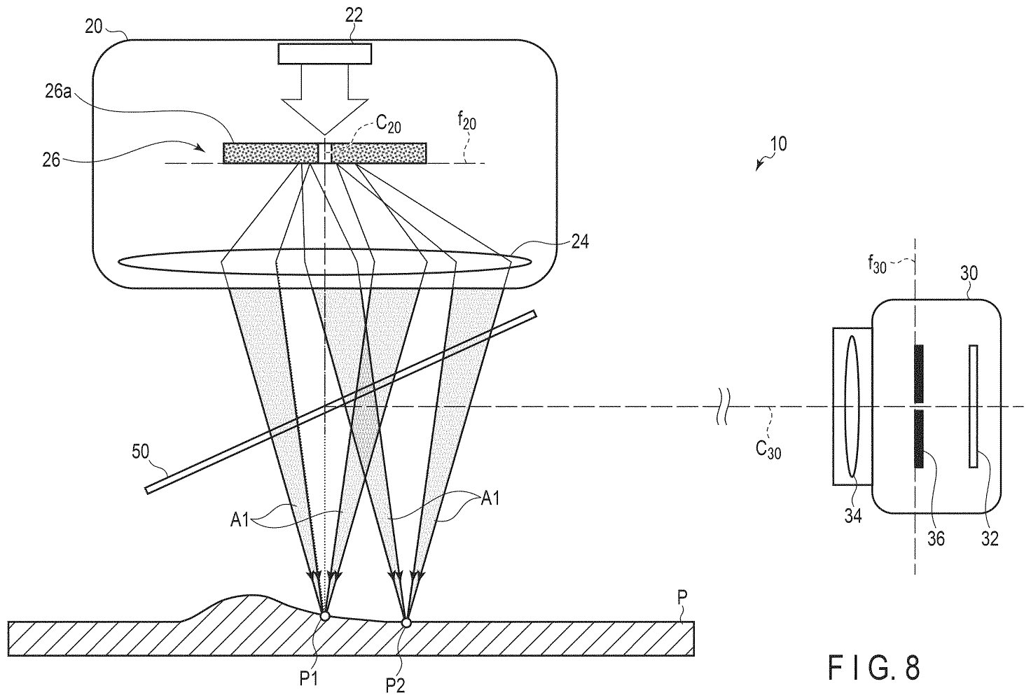

An optical inspection apparatus 10 according to the present embodiment will be described below with reference to FIG. 8. The basis of the present embodiment is the same as that of the second embodiment (FIG. 6). Therefore, in the present embodiment, only differences will be described.

FIG. 8 is a schematic cross-sectional view of the optical inspection apparatus 10 according to the present embodiment. The optical inspection apparatus 10 according to the present embodiment includes an illumination portion 20, an imaging portion 30, and a beam splitter 50. Illumination of the object P and imaging of the object P are performed via the beam splitter 50. By using the beam splitter 50, the illumination optical axis C₂₀ and the imaging optical axis C₃₀ can be optically coaxial.

In the present embodiment, it is assumed that the illumination portion 20 includes a light source or a projection portion. In the present embodiment, it is assumed that the illumination portion 20 includes a projection portion 22. The projection portion 22 can electrically and instantaneously change a projected image. However, the projection portion 22 may mechanically switch the projected image. In the present embodiment, it is assumed that the projector 22 is a color projector, and is a digital lighting processing (DLP) device including a digital micromirror device (DMD). However, the present embodiment is not limited thereto.

There are various types of the projection portion 22. For example, the projection portion 22 can enlarge an image, reduce an image and project an image at the same size using a liquid crystal optical element (LCD). The projection portion 22 can electrically and instantaneously switch a projected image. Alternatively, the projection portion 22 may be capable of mechanically switching a projected image instantaneously. For example, a slide projector that mechanically replaces a slide with another slide and projects the slide, an overhead projector (OHP) that projects an image drawn on a transparent sheet, or the like may be used. Alternatively, the projection portion 22 may use a light source capable of electrically switching on and off and an imaging optical element in combination to generate a projection pattern. Alternatively, the projection portion 22 may generate a projection pattern with a combination of a color filter and an imaging optical element, a combination of a phosphor sheet or a phosphor coating plate and an imaging optical element, a combination of a dichroic mirror and an imaging optical element, a combination of a polarizing plate and an imaging optical element, or the like.

The illumination portion 20 includes an imaging optical element 24 for illumination. The imaging optical element 24 for illumination may be any imaging optical element as long as it is an imaging optical element, but it is assumed that the imaging optical element 24 for illumination is an assembled lens. The focal plane of the imaging optical element 24 for illumination is an illumination focal plane f₂₀.

The illumination portion 20 further includes a second light selection portion 26. In the present embodiment, the light selection portion 26 is a transmissive diffusion plate. The projection portion 22 irradiates the diffusion plate 26 with the projection pattern.

An operation of the optical inspection apparatus 10 according to the present embodiment will be described based on the above configuration.

The processing portion 40 forms (forms an image of) the projection pattern on the transmissive diffusion plate 26 by the projection portion 22 included in the illumination portion 20. The projection pattern is formed, for example, in a region excluding a region on the illumination optical axis C₂₀ and the vicinity of the illumination optical axis C₂₀, and forms a first selection region 26a in a region surrounding the optical axis C₂₀. The first selection region 26a is formed in an annular shape by light having the first wavelength spectrum, for example. However, the projection pattern in the present embodiment is not limited thereto, and the projection pattern may have any shape, may have any light intensity distribution, may have any color, may include a plurality of colors at the same time, may have any polarization, or may have any shape. Thereafter, light that passed through the diffusion plate 26 is transformed into light beams to be directed in various directions, and is emitted toward the imaging optical element 24 for illumination. Further, the light that passed through the diffusion plate 26 reaches substantially the entire surface of the lens which is the imaging optical element 24 for illumination that is provided in the illumination portion 20. As a result, the illumination portion 20 can illuminate a wide range of the object P. That is, the irradiation field to the object P is widened by using the illumination portion 20. Therefore, by using the illumination portion 20 according to the present embodiment, a light beam flux at the first solid angle A1 can be formed in the irradiation field in a wide region of the object P. On the other hand, if the diffusion plate 26 is not provided, light from the projection portion 22 does not reach the entire lens surface of the imaging optical element 24 for illumination, and a light beam flux at the first solid angle A1 cannot be formed in a wide range. That is, there is an effect that a light beam flux at the first solid angle A1 can be formed in a wide range by the second light selection portion 26.

The processing portion 40 forms light beam fluxes at the first solid angle A1 simultaneously at least at the first object point P1 and the second object point P2 by the illumination portion 20 (step S11), and acquires a first captured image by the imaging portion 30 (step S11). Next, similarly to the light beam fluxes formed at the first solid angle A1, the processing portion 40 changes the projection pattern of the projection portion 22 of the illumination portion 20 to simultaneously form light beam fluxes at the third solid angle A3 and the fourth solid angle A4 at least at the first object point P1 and the second object point P2 (step S11), and acquires a second captured image by the imaging portion 30 (step S21). As a result, the processing portion 40 can acquire the information regarding the object surface P using the first captured image and the second captured image (step S3). Furthermore, in the present embodiment, the projection pattern can be instantaneously changed by the projection portion 22. Therefore, there is an effect that light beam fluxes at the first solid angle A1 or the third solid angle A3 and the fourth solid angle A4 can be instantaneously formed. As a result, the optical inspection apparatus 10 according to the present embodiment can acquire the information regarding the object P at a higher speed.

By using the illumination portion 20 according to the present embodiment, light beam fluxes at the same solid angle can be simultaneously formed over a wide irradiation field for the object P. That is, since the illumination portion 20 according to the present embodiment is used, there is an effect that light beam fluxes at the same solid angle can be simultaneously formed at least at the first object point P1 and the second object point P2. As a result, the optical inspection apparatus 10 according to the present embodiment can acquire the information regarding the object P at a higher speed. Furthermore, since the optical inspection apparatus 10 can be simultaneously compare at least the first object point P1 and the second object point P2, the optical inspection apparatus 10 can detect a difference in object information between the first object point P1 and the second object point P2.

As described above, there is an effect that the accuracy of estimating the inclination angle θ can be increased by recursively and repeatedly using the method of the optical inspection apparatus 10 according to the present embodiment. For example, after the optical inspection apparatus 10 acquires the second captured image, the optical inspection apparatus 10 may form the fifth solid angle and the sixth solid angle with respect to the third solid angle A3 similarly to the third solid angle A3 and the fourth solid angle A4 with respect to the first solid angle A1. Similarly to the third solid angle A3 and the fourth solid angle A4 with respect to the first solid angle A1, the optical inspection apparatus 10 may form the seventh solid angle and the eighth solid angle with respect to the fourth solid angle A4. This makes it possible to exponentially increase the number of solid angles and accordingly improve the accuracy of estimating the inclination angle θ. In the present embodiment, only the first wavelength spectrum as projection pattern, that is, white light is used. Even if only one color is used in this manner, there is an effect that the accuracy of acquiring the information regarding the object P can be improved by using the optical inspection apparatus 10 of the present embodiment inductively (or repeatedly).

Therefore, according to the present embodiment, it is possible to provide an optical inspection apparatus 10, an optical inspection method, and a non-transitory storage medium storing an optical inspection program, which are capable of acquiring the information regarding the object P with illumination of a small number of colors (wavelength spectrum).

In the present embodiment, an example in which the illumination portion 20 includes the diffusion plate 26 has been described. For example, the diffusion plate 26 is not necessarily required as long as light from the light source 22 can reach the entire surface of the imaging optical element 24 for illumination.

### (Modification 1)

The projection portion 22 of the illumination portion 20 illustrated in FIG. 8 may be a color projector, and in this case, the projection pattern can be formed using light having at least two different wavelength spectra. These wavelength spectra are referred to as a first wavelength spectrum and a second wavelength spectrum, respectively. Then, the imaging portion 30 including the color image sensor 32 can simultaneously acquire the first captured image and the second captured image by distinctively receiving the two wavelength spectra. As a result, the optical inspection apparatus 10 according to the present Modification 1 can acquire the information regarding the object P at a higher speed.

Furthermore, there is an effect that the processing portion 40 can increase the accuracy of estimating the inclination angle θ by recursively and repeatedly using the method of the optical inspection apparatus 10 according to the present Modification 1. For example, after the optical inspection apparatus 10 acquire the second captured image, similarly to the third solid angle A3 and the fourth solid angle A4 with respect to the first solid angle A1, the optical inspection apparatus 10 may form light beam fluxes having the first wavelength spectrum at the fifth solid angle and the sixth solid angle with respect to the third solid angle A3. Similarly to the third solid angle A3 and the fourth solid angle A4 with respect to the first solid angle A1, the optical inspection apparatus 10 may form light beam fluxes having the second wavelength spectrum at the seventh solid angle and the eighth solid angle with respect to the fourth solid angle A4. This makes it possible to exponentially increase the number of solid angles and accordingly improve the accuracy of estimating the inclination angle. In the present Modification 1, the first wavelength spectrum and the second wavelength spectrum, that is, only two colors are used. Even if only two colors are used in this manner, there is an effect that the optical inspection apparatus 10 can improve the accuracy of acquiring the information regarding the object P by using the optical inspection apparatus 10 of the present Modification 1 inductively (or repeatedly). However, the present Modification 1 is not limited to two colors, any color may be used.

Therefore, the optical inspection apparatus 10 according to the present Modification 1 may acquire the information regarding the object P in accordance with the processing procedure illustrated in FIG. 3, or may acquire the information regarding the object P in accordance with the processing procedure illustrated in FIG. 5.

### (Modification 2)

The second light selection portion 26 illustrated in FIG. 8 may be, for example, thin transparent glass having a surface coated with a phosphor. Here, it is assumed that a phosphor that emits green light (first wavelength spectrum) by blue excitation is applied to the first selection region 26a. However, the light selection portion 26 may be any unit as long as it transforms a wavelength of light using a phosphor (or a fluorescent agent). It is assumed that a blue laser light source is provided instead of the projection portion 22 of the illumination portion 20. As a result, the second selection unit 26 is irradiated with blue laser light from the blue laser beam source 22, and thus there is an effect that the light of the first wavelength spectrum can reach the entire lens surface of the imaging optical element 24 for illumination. In addition, heat resistance of the phosphor is often considered, but in the present modification, the phosphor is spaced apart from the light source 22 that can be a heat source. Therefore, there is an effect that the durability of the second light selection portion 26 including the phosphor is improved.

### (Modification 3)

The second light selection portion 26 illustrated in FIG. 8 may be a color filter (wavelength filter) having a transmission spectrum region that transmits the first wavelength spectrum in a first wavelength region.

That is, it is assumed that the light selection portion 26 includes a region that is centered on the optical axis C₂₀ of the light selection portion 26 and transmits light having the first wavelength spectrum that reached the vicinity of the center, and a region that surrounds the region centered on the optical axis C₂₀ and shields light having the first wavelength spectrum and transmits light having the second wavelength spectrum different from the first wavelength spectrum. Therefore, the light selection portion 26 may transmit light having the first wavelength spectrum that reached the optical axis C₂₀ of the light selection portion 26, and may shield light having a wavelength spectrum different from the first wavelength spectrum.

It is assumed that a white LED is provided instead of the projection portion 22 of the illumination portion 20. Accordingly, there is an effect that white LED 22 can easily form a light beam flux at the first solid angle A1.

### (Modification 4)

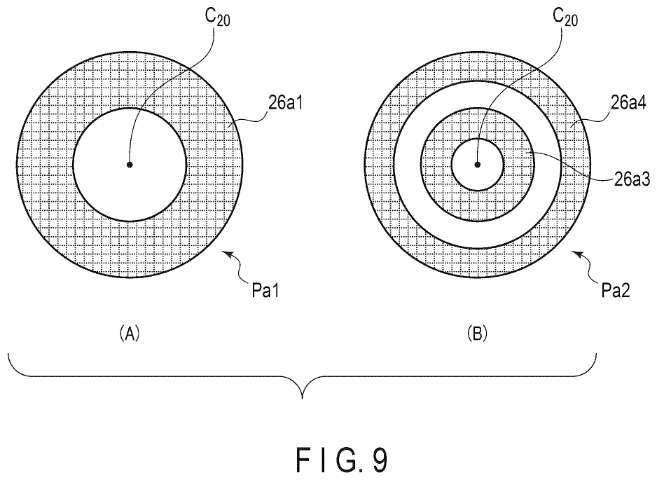

There are various projection patterns by the projection portion 22 described in the fourth embodiment (see FIG. 8). One example thereof is illustrated in FIG. 9. FIG. 9 illustrates, side by side, examples of projection patterns projected from the projection portion 22 to the first selection region 26a on the illumination focal plane f₂₀ orthogonal to the illumination optical axis C₂₀. The example illustrated in FIG. 9 (A) is a first projection pattern Pa1 projected from the projection portion 22 toward the second light selection portion 26 on the focal plane f₂₀ of the imaging optical element 24 for illumination. The example illustrated in FIG. 9 (B) is a second projection pattern Pa2 projected from the projection portion 22 toward the second light selection portion 26 on the focal plane f₂₀ of the imaging optical element 24 for illumination.

The processing portion 40 causes the projection portion 22 to project the first projection pattern Pa1 toward the second light selection portion 26 on the focal plane f₂₀ of the imaging optical element 24 for illumination, thus, light beam fluxes at the first solid angle A1 are simultaneously formed at least at the first object point P1 and the second object point P2 of the object P (step S11). The processing portion 40 causes the imaging portion 30 to acquire a first captured image (step S11). Next, similarly to the light beam fluxes formed at the first solid angle A1, the processing portion 40 causes the projection portion 22 to project the second projection pattern Pa2 that is changed from the first projection pattern Pa1 toward the second light selection portion 26 on the focal plane f₂₀ of the imaging optical element 24 for illumination, thus, light beam fluxes at the third solid angle A3 and the fourth solid angle A4 are simultaneously formed at least at the first object point P1 and the second object point P2 (step S11). The processing portion 40 causes the imaging portion 30 to acquire a second captured image (step S11). As a result, the processing portion 40 can acquire the information regarding the object surface P using the first captured image and the second captured image (step S3).

The illumination portion 20 according to the present modification can instantaneously change the projection patterns Pa1 and Pa2 by the projection portion 22. Therefore, there is an effect that the illumination portion 20 can instantaneously form light beam fluxes at the first solid angle A1 or the third solid angle A3 and the fourth solid angle A4. As a result, the optical inspection apparatus 10 according to the present modification can acquire the information regarding the object P at a higher speed.

According to the present modification, for example, the illumination portion 20 can form an axisymmetric solid angle with respect to the illumination optical axis C₂₀, so that the optical inspection apparatus 10 can acquire angle information with respect to the illumination optical axis C₂₀ as the inclination angle θ of the inclined surface of the object P.

### (Modification 5)

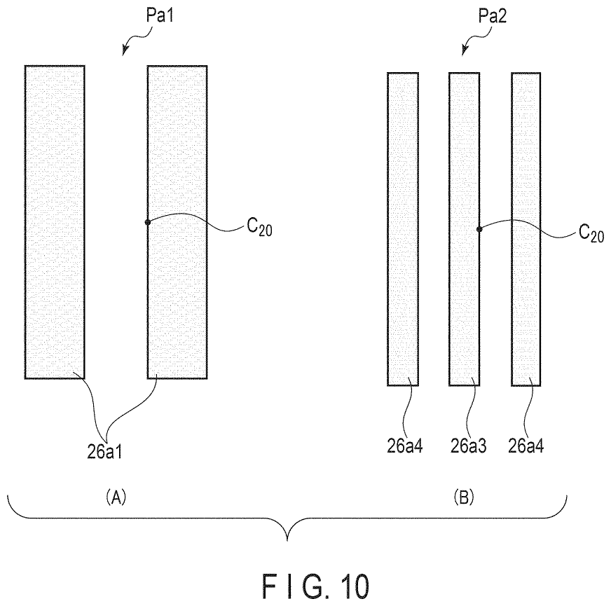

There are various projection patterns by the projection portion 22 described in the fourth embodiment (see FIG. 8) other than Modification 4. One example thereof is illustrated in FIG. 10. FIG. 10 illustrates, side by side, examples of projection patterns projected from the projection portion 22 to the first selection region 26a on the illumination focal plane f₂₀ orthogonal to the illumination optical axis C₂₀. The example illustrated in FIG. 10(A) is a first projection pattern Pa1 projected from the projection portion 22 toward the second light selection portion 26 on the focal plane f₂₀ of the imaging optical element 24 for illumination. The example illustrated in FIG. 10(B) is a second projection pattern Pa2 projected from the projection portion 22 toward the second light selection portion 26 on the focal plane f₂₀ of the imaging optical element 24 for illumination.

The processing portion 40 causes the projection portion 22 to project the first projection pattern Pa1 toward the second light selection portion 26 on the focal plane f₂₀ of the imaging optical element 24 for illumination, thus, light beam fluxes at the first solid angle A1 are simultaneously formed at least at the first object point P1 and the second object point P2 of the object P (step S11). The processing portion 40 causes the imaging portion 30 to acquire a first captured image (step S21). Next, similarly to the light beam fluxes formed at the first solid angle A1, the processing portion 40 causes the projection portion 22 to project the second projection pattern Pa2 that is changed from the first projection pattern Pa1 toward the second light selection portion 26 on the focal plane f₂₀ of the imaging optical element 24 for illumination, thus, light beam fluxes at the third solid angle A3 and the fourth solid angle A4 are simultaneously formed at least at the first object point P1 and the second object point P2 (step S11). The processing portion 40 causes the imaging portion 30 to acquire a second captured image (step S21). As a result, the processing portion 40 can acquire the information regarding the object surface P using the first captured image and the second captured image (step S3).

The illumination portion 20 according to the present modification can instantaneously change the projection patterns Pa1 and Pa2 by the projection portion 22. Therefore, there is an effect that the illumination portion 20 can instantaneously form light beam fluxes at the first solid angle A1 or the third solid angle A3 and the fourth solid angle A4. As a result, the optical inspection apparatus 10 according to the present modification can acquire the information regarding the object P at a higher speed.

In the present modification, since the projection patterns Pa1 and Pa2 have translational symmetry in a uniaxial direction, the optical inspection apparatus 10 can acquire angle information with respect to a direction orthogonal to the translational symmetry direction as the inclination angle θ of the inclined surface of the object P.

### (Modification 6)

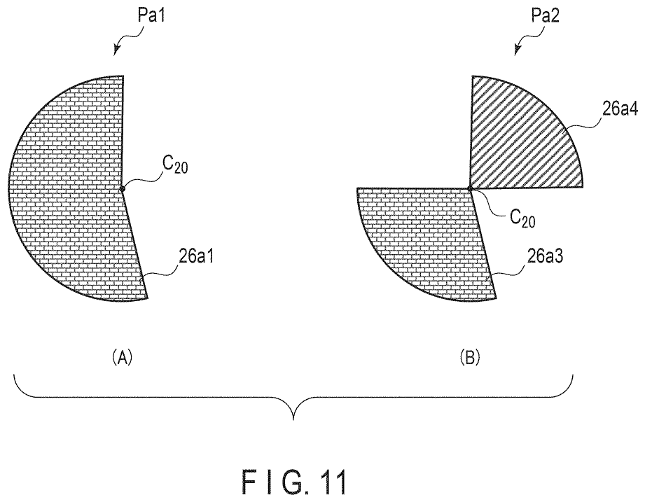

There are various projection patterns by the projection portion 22 described in the fourth embodiment (see FIG. 8) other than Modification 4 and Modification 5. One example thereof is illustrated in FIG. 11. FIG. 11 illustrates, side by side, examples of projection patterns projected from the projection portion 22 to the first selection region 26a on the illumination focal plane f₂₀ orthogonal to the illumination optical axis C₂₀. The example illustrated in FIG. 11(A) is a first projection pattern Pa1 projected from the projection portion 22 toward the second light selection portion 26 on the focal plane f₂₀ of the imaging optical element 24 for illumination. The example illustrated in FIG. 11(B) is a second projection pattern Pa2 projected from the projection portion 22 toward the second light selection portion 26 on the focal plane f₂₀ of the imaging optical element 24 for illumination.

The processing portion 40 causes the projection portion 22 to project the first projection pattern Pa1 toward the second light selection portion 26 on the focal plane f₂₀ of the imaging optical element 24 for illumination, thus, light beam fluxes at the first solid angle A1 are simultaneously formed at least at the first object point P1 and the second object point P2 of the object P (step S11). The processing portion 40 causes the imaging portion 30 to acquire a first captured image (step S21). Next, similarly to the light beam fluxes formed at the first solid angle A1, the processing portion 40 causes the projection portion 22 to project the second projection pattern Pa2 that is changed from the first projection pattern Pa1 toward the second light selection portion 26 on the focal plane f₂₀ of the imaging optical element 24 for illumination, thus, light beam fluxes at the third solid angle A3 and the fourth solid angle A4 are simultaneously formed at least at the first object point P1 and the second object point P2 (step S11). The processing portion 40 causes the imaging portion 30 to acquire a second captured image (step S21). As a result, the processing portion 40 can acquire the information regarding the object surface P using the first captured image and the second captured image (step S3).

The illumination portion 20 according to the present modification can instantaneously change the projection patterns Pa1 and Pa2 by the projection portion 22. Therefore, there is an effect that the illumination portion 20 can instantaneously form light beam fluxes at the first solid angle A1 or the third solid angle A3 and the fourth solid angle A4. As a result, the optical inspection apparatus 10 according to the present modification can acquire the information regarding the object P at a higher speed.

In the present modification, since the projection patterns Pa1 and Pa2 have a distribution in an azimuth angle direction, the optical inspection apparatus 10 can acquire angle information with respect to the azimuth angle direction as the inclination angle θ of the inclined surface of the object P.

### (Modification 7)

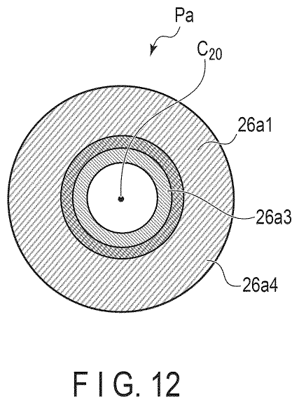

There are various projection patterns by the projection portion 22 described in the fourth embodiment (see FIG. 8) other than Modification 4, Modification 5, and Modification 6. One example thereof is illustrated in FIG. 12. FIG. 12 illustrates examples of projection patterns projected from the projection portion 22 to the first selection region 26a on the illumination focal plane f₂₀ orthogonal to the illumination optical axis C₂₀. Here, it is assumed that light having the first wavelength spectrum is blue light having a peak wavelength of 450 nm and a wavelength width of 100 nm. In addition, it is assumed that light having the second wavelength spectrum is red light having a peak wavelength of 650 nm and a wavelength width of 100 nm.

The processing portion 40 causes the projection portion 22 to project the first projection pattern Pa1 toward the second light selection portion 26 on the focal plane f₂₀ of the imaging optical element 24 for illumination, thus, light beam fluxes are simultaneously irradiated at least the first object point P1 and the second object point P2 (step S12). Here, it is assumed that a first selection region 26al is formed of light having the first wavelength spectrum, and a third selection region 26a3 and a fourth selection region 26a4 are formed of light having the second wavelength spectrum. Then, a light beam flux at the first solid angle A1 is formed by the light from the first selection region 26a1, and light beam fluxes at the third solid angle A3 and the fourth solid angle A4 is formed by the light from the third selection region 26a3 and the fourth selection region 26a4. Then, the processing portion 40 causes the imaging portion 30 including the color image sensor 32 to acquire a captured image (step S22). The color image sensor 32 can distinguish between the blue light and the red light, and sets a captured image with the blue light as, for example, a first captured image and a captured image with the red light as, for example, a second captured image. As a result, the processing portion 40 can acquire the information regarding the object surface P using the first captured image and the second captured image (step S3). the optical inspection apparatus 10 in the present modification can simultaneously acquire the first captured image and the second captured image without instantaneously changing the projection pattern by the projection portion 22. As a result, the optical inspection apparatus 10 according to the present modification can acquire the information regarding the object P at a high speed.

In addition to the projection patterns described above, there are various projection patterns by the projection portion 22. That is, any projection pattern may be used as long as the light beam fluxes at the first solid angle A1, the third solid angle A3, and the fourth solid angle A4 can be formed at the same time or in time series. However, in the case of forming them at the same time, it is necessary to distinguish the light beam fluxes at the third solid angle A3 and the fourth solid angle A4 from the light beam flux at the first solid angle A1 by wavelength, polarization, intensity, and the like. If this is satisfied, the projection pattern shape, the color (wavelength spectrum) of the light, the polarization of the light, the intensity or intensity distribution of the light may be arbitrary. Furthermore, the light beam fluxes at the third solid angle and the fourth solid angle A4 may have different wavelengths, polarizations, and intensities.

### Application Example 1

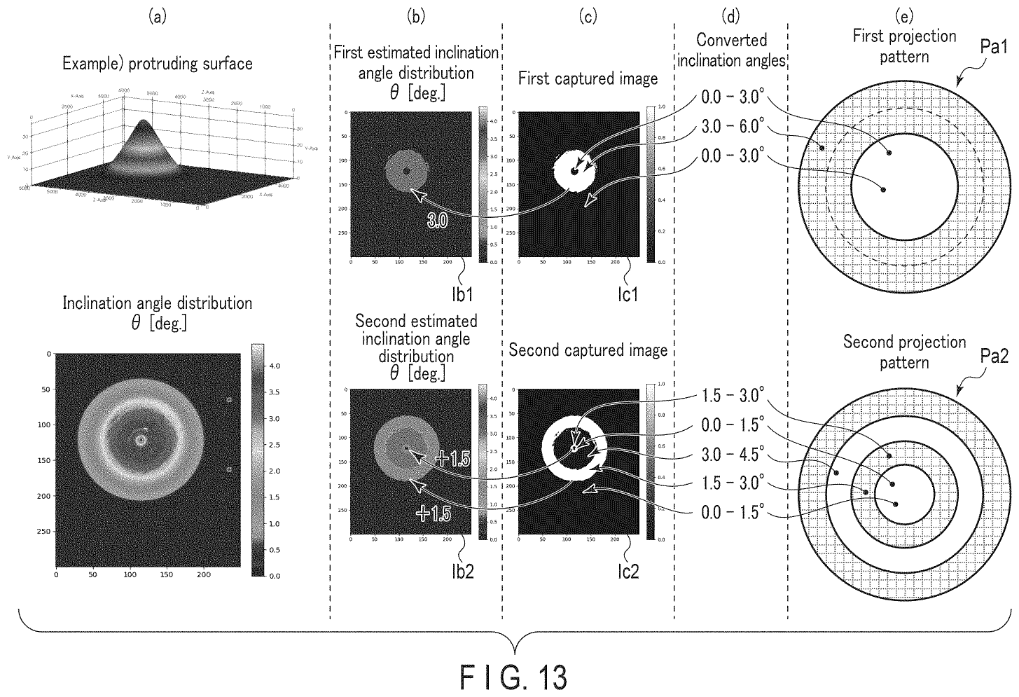

Application Example 1 of the optical inspection apparatus 10 according to the present embodiment will be described below with reference to FIG. 13. The optical inspection apparatus 10 used in the present Application Example 1 is the same as the optical inspection apparatus 10 described in the fourth embodiment (FIG. 8).

In the present Application Example 1, an algorithm will be described that the processing portion 40 acquires a captured image each time a projection pattern is formed on the illumination focal plane f₂₀ of the imaging optical element 24 for illumination, sums increments of the inclination angle θ, and repeatedly acquires the inclination angle θ of the object surface P.

An operation of the optical inspection apparatus 10 in the present Application Example 1 will be described.

As illustrated in FIG. 13(a), a reflective protruding surface is taken as an example of the surface of the object P. It is assumed that the protruding surface is sufficiently smooth, and the reflectivity means that incident light is specularly reflected. In FIG. 13(a), a substantially circular cone having a height of approximately 50 μm and a diameter of approximately 2000 μm is drawn by color-coding for each inclination angle. An inclination angle at a position continuous to the bottom surface of the substantially circular cone and an inclination angle of a top portion of the substantially circular cone are 0°.

The processing portion 40 causes the projection portion 22 of the illumination portion 20 to project projection patterns Pa1 and Pa2 having the same outer diameter illustrated in FIG. 13(e) toward the focal plane f₂₀ of the imaging optical element 24 for illumination. In this case, it is assumed that the projection portion 22 projects white light. Therefore, the processing portion 40 cause the projection portion 22 to sequentially project the projection patterns Pa1 and Pa2. The first projection pattern Pa1 is one circular ring. On the other hand, the second projection pattern Pa2 is two circular rings. That is, the number of circular rings of the second projection pattern Pa2 is twice that of the first projection pattern Pa1. Note that the first projection pattern Pa1 is the same as that illustrated in FIG. 9(A), and the second projection pattern Pa2 is the same as that illustrated in FIG. 9(B).

In the second projection pattern Pa2, white light is not projected between a portion indicated by a broken line in one circular ring of the first pattern Pa2 and an inner edge of the circular ring. Furthermore, the second projection pattern Pa2 is divided into two in the radial direction inside the inner edge of one ring of the first pattern Pa1, and the white light is projected on the outer ring and the white light is not projected on the inner ring.

Then, first, the processing portion 40 causes the projection portion 22 to project the first projection pattern Pa1 toward the focal plane f₂₀ of the imaging optical element 24 for illumination. Thus, the object surface P is irradiated with a light beam flux at the first solid angle A1 (step S11). The processing portion 40 causes the imaging portion 30 to image the object P, and acquires a first captured image (step S21). The solid angle excluding the first solid angle A1 is set as the second solid angle A2.

Next, the processing portion 40 causes the projection portion 22 to project the second projection pattern Pa2 toward the focal plane f₂₀ of the imaging optical element 24 for illumination. Thus, the object surface P is irradiated with light beam fluxes at the third solid angle A3 and the fourth solid angle A4 (step S11). The processing portion 40 causes the imaging portion 30 to image the object P, and acquires a second captured image (step S21). In this case, the third solid angle A3 is included in the first solid angle A1. The fourth solid angle A4 is included in the second solid angle A2. Then, the light beam fluxes at the third solid angle A3 and the fourth solid angle A4 are simultaneously formed by the illumination portion 20.

FIG. 13(c) illustrates a first captured image Ic1 and a second captured image Ic2 captured by the imaging portion 30. In the first captured image Ic1 and the second captured image Ic2, portions where the light intensity is strong are white, and portions where light intensity is weak are black.

In the first captured image Ic1, black regions have a converted inclination angle of 0.0° to 3.0°. A white region has a converted inclination angle of 3.0° to 6.0°. Thus, the angular resolution in this case is 3.0°. Then, in the algorithm in this case, the estimated inclination angle of the white region of the first captured image Ic1 is set to 3.0° which is the minimum value of the converted inclination angle. This distribution is set as a first estimated inclination angle distribution, and is indicated by reference sign Ib1 in FIG. 13(b).

In the second captured image Ic2, black, white, black, white, and black regions appear in order from the outside toward the inside (vertex). The angular resolution in this case is 1.5°. In the second captured image Ic2, each of the black regions has a converted inclination angle of 0.0° to 1.5° or 3.0° to 4.5°. Each of the white regions has a converted inclination angle of 1.5° to 3.0° or 4.5° to 6.0°. Then, in the processing portion 40 using the above algorithm, with respect to an inclination angle of a region where the first captured image is black and the second captured image is white, an angle of 1.5° corresponding to the angular resolution is added to the first estimated inclination angle. In addition, in the processing portion 40, calculation is performed to maintain an inclination angle of a region where the first captured image is white and the second captured image is black as it is. By performing such calculation in the processing portion 40, a shape reflecting an angle is created for each of a portion where the object point described above appears and a portion where the object point does not appear.

Although not illustrated, a third pattern light Pa3 further forms a solid angle with respect to the second pattern light Pa2 as described above, and the processing portion 40 acquire a third captured image. The angular resolution in this case is 0.75°. Then, in the processing portion 40 using the above algorithm, with respect to an inclination angle of a region where the second captured image is black and the third captured image is white, an angle of 0.75° corresponding to the angular resolution is added to the estimated inclination angle. In addition, in the processing portion 40, calculation is performed to maintain an inclination angle of a region where the second captured image is white and the third captured image is black as it is. By performing such calculation in the processing portion 40, a shape reflecting an angle is created for each of a portion where the object point described above appears and a portion where the object point does not appear.

Thereafter, similarly, the number of circular rings of the projection pattern is increased by two times in the processing portion 40. That is, the number of circular rings of a third projection pattern is four, and the number of circular rings of a fourth projection pattern is eight. Then, the processing portion 40 acquire a captured image for each projection pattern. As a result, there is an effect that the accuracy of estimating the inclination angle distribution θ using the optical inspection apparatus 10 is improved as it is repeated. That is, there is an effect that the number of gradations of the angular resolution in the optical inspection apparatus 10 is exponentially increased by 2 times, 4 times, 8 times, and 16 times.

Here, the estimation accuracy of the estimated inclination angle distribution obtained by combining the first captured image Ic1 and the second captured image Ic2 is higher than that of an estimated inclination angle distribution obtained from the first captured image Ic1. That is, there is an effect that the estimation accuracy in the optical inspection apparatus 10 is improved by increasing the number of captured images and combining the captured images.

Here, the estimated inclination angle distribution using the first captured image Ic1 and the second captured image Ic2 has an angular range of 0° to 6° and an angular resolution of 1.5°. That is, in the optical inspection apparatus 10, the estimated inclination angle distribution has an angular resolution of four gradations. If the number of circular rings of the second projection pattern Pa2 is not twice the number of circular rings of the first projection pattern Pa1, for example, if the number of circular rings of the second projection pattern Pa2 is one, only angular resolution of up to three gradations can be obtained using the first captured image Ic1 and the second captured image Ic2 in the optical inspection apparatus 10. That is, as in the present embodiment, the solid angle included in the first solid angle A1 is set as the third solid angle A3, the solid angle included in the second solid angle A2 is set as the fourth solid angle A4, and light beam fluxes at the third solid angle A3 and the fourth solid angle A4 are simultaneously formed by the illumination portion 20, so that there is an effect that the accuracy of estimating the inclination angle θ using the optical inspection apparatus 10 can be improved.

### Application Example 2

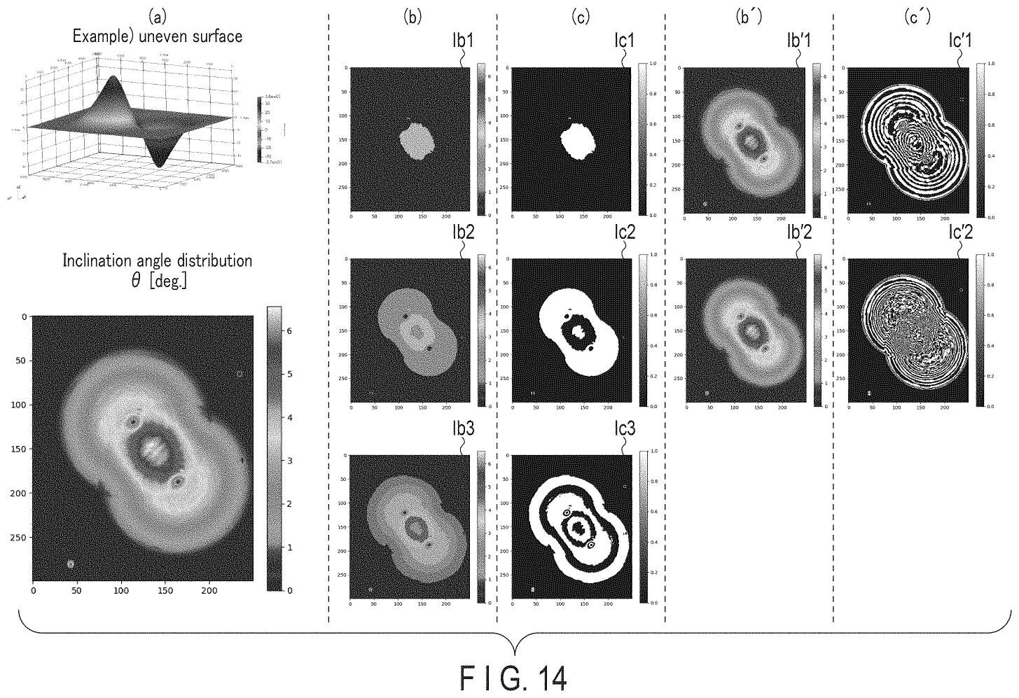

FIG. 14(a) illustrates an algorithm exactly similar to that in Application Example 1 (described above) and applied to a slightly complex uneven surface in contrast to the protruding surface illustrated in FIG. 13(a). The object P illustrated in FIG. 14(a) is an example in which a protruding cone having a height of, for example, approximately 50 μm with respect to the flat surface and a diameter of approximately 2000 μm and a recessed cone having a depth of, for example, approximately 50 μm with respect to the flat surface and a diameter of approximately 2000 μm are adjacent to each other. That is, FIG. 14(a) illustrates an example in which a reflective protruding surface and a reflective recessed surface are combined as the surface of the object P. It is assumed that the protruding surface and the recessed surface are sufficiently smooth, and the reflectivity means that incident light is specularly reflected.

Also in this example, the processing portion 40 cause the object surface P to be sequentially irradiated with the first projection pattern Pa1 and the second projection pattern Pa2 illustrated in FIG. 13(e), and the third projection pattern . . . (not illustrated), and the processing portion 40 acquire the first captured image, the second captured image, the third captured image, . . . illustrated in FIG. 14(c), respectively.

Then, as illustrated in FIG. 14(b), the processing portion 40 obtains a first estimated inclination angle distribution Ib1, a second estimated inclination angle distribution Ib2, and a third estimated inclination angle distribution Ib3 from these captured images while appropriately adding the angular resolution according to the determination of whether the object point appears or does not appear on the images.

Then, the processing portion 40 increases the accuracy of the inclination angle distribution while repeating the processing. In this way, in Application Example 2, the optical inspection apparatus 10 can obtain information (inclination angle θ) regarding each object point of the object P.

Note that, although not illustrated in detail, for example, the optical inspection apparatus 10 can obtain a captured image illustrated in the upper part of FIG. 14(c′) with appropriate pattern light, and a captured image illustrated in the lower part of FIG. 14(c′) with more finely divided pattern light. Then, the optical inspection apparatus 10 can obtain a first estimated inclination angle distribution Ib′1 and a second estimated inclination angle distribution Ib′2 illustrated in FIG. 14(b′).

Also in Application Example 2, there is an effect that the accuracy of estimating the inclination angle distribution θ using the optical inspection apparatus 10 is improved as it is repeated. That is, for example, there is an effect that the number of gradations of the angular resolution in the optical inspection apparatus 10 is exponentially increased by 2 times, 4 times, 8 times, and 16 times. As described above, there is an effect that the inclination angle distributions of various surfaces can be accurately acquired by repeatedly using the processing portion 40 using the above algorithm.

### Application Example 3

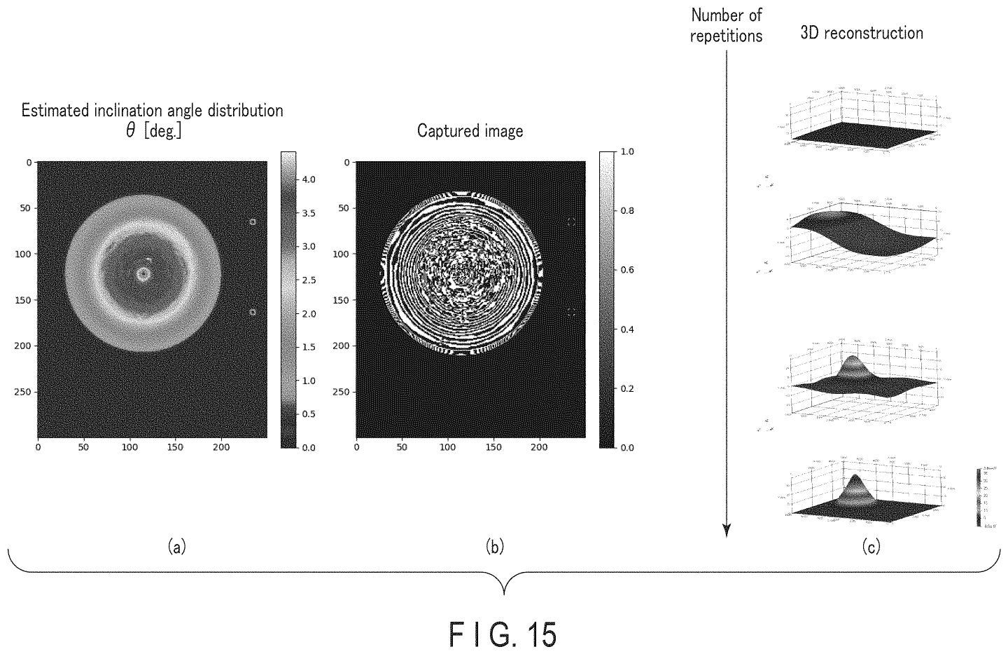

The object surface P is a set of object points. It is known that once the inclination angle distribution e of each object point of the object P is obtained, the three-dimensional shape of the object surface P can be reconstructed using a deep neural network as the processing portion 40. For example, FIG. 15(a) illustrates an estimated inclination angle distribution e which was repeatedly estimated 5 times with respect to the protruding surface illustrated in FIG. 13 in the deep neural network as the processing portion 40. FIG. 15(b) illustrates a reconstructed captured image of a three-dimensional shape of the protruding surface illustrated in FIG. 13 that is obtained by repeatedly reconstructing the three-dimensional shape using the estimated inclination angle distribution θ. Therefore, by acquiring the inclination angle θ for each object point, the processing portion 40 of the optical inspection apparatus 10 according to the present embodiment can measure the shape of the object P as illustrated in the lowermost part of FIG. 15(c) (the same as FIG. 13(a)). As described above, there is an effect that the three-dimensional shape of the object P can be acquired in the optical inspection apparatus 10.

Note that a shape having a protrusion and a recess with respect to the flat surface as illustrated in FIG. 14(a) can be similarly reconstructed by using a deep neural network as the processing portion 40. Therefore, the processing portion 40 of the optical inspection apparatus 10 according to the present embodiment can measure the shape of the object P even if the shape is appropriately complex.

The example of measuring the shape of the object P has been described, but the optical inspection apparatus 10, the optical inspection method, and the optical inspection program may be used to inspect the surface of the object P or the inner surface of the object P.

According to at least one of the embodiments described above, it is possible to provide the optical inspection apparatus 10, the optical inspection method, and the non-transitory storage medium storing the optical inspection program, which are capable of acquiring the information regarding the object P with illumination of a small number of colors (wavelength spectrum).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical inspection apparatus comprising:
an illumination portion that is configured to irradiate at least a first object point of an object with a light beam flux at one or a plurality of solid angles;
an imaging portion that is configured to acquire an image of the object according to illumination with the light beam flux at the one or plurality of solid angles; and
a processor
that causes the first object point of the object to be irradiated with a light beam flux at a first solid angle by first illumination light from the illumination portion, and is configured to set a solid angle not including the first solid angle as a second solid angle,
that is configured to acquire a first captured image of the object using the imaging portion by illumination with the first illumination light,
that is configured to set a solid angle included in the first solid angle as a third solid angle, is configured to set a solid angle included in the second solid angle as a fourth solid angle, causes at least the first object point to be irradiated with light beam fluxes at the third solid angle and the fourth solid angle by second illumination light from the illumination portion,
that is configured to acquire a second captured image of the object using the imaging portion by illumination with the second illumination light, and
that is configured to acquire information regarding the object by the first captured image and the second captured image.

2. The optical inspection apparatus according to claim 1, wherein the processor causes at least the first object point of the object to be irradiated with a light beam flux having a first wavelength spectrum at the first solid angle as the first illumination light of the illumination portion, and causes at least the first object point to be irradiated with light beam fluxes having the first wavelength spectrum at the third solid angle and the fourth solid angle as the second illumination light of the illumination portion before or after the irradiation with the light beam flux at the first solid angle.

3. The optical inspection apparatus according to claim 1, wherein the processor causes at least the first object point of the object to be irradiated with a light beam flux having a first wavelength spectrum at the first solid angle as the first illumination light of the illumination portion, and causes at least the first object point to be simultaneously irradiated with light beam fluxes having a second wavelength spectrum different from the first wavelength spectrum at the third solid angle and the fourth solid angle as the second illumination light of the illumination portion.

4. The optical inspection apparatus according to claim 1, wherein in a case where an object point different from the first object point of the object is set as a second object point, the processor
causes the second object point in addition to the first object point of the object to be irradiated with a light beam flux at the first solid angle by the first illumination light from the illumination portion,
is configured to acquire the first captured image of the object using the imaging portion by the illumination with the first illumination light,
causes the second object point in addition to the first object point to be irradiated with light beam fluxes at the third solid angle and the fourth solid angle by the second illumination light from the illumination portion,
acquire the second captured image of the object using the imaging portion, and
is configured to acquire information regarding the object by the first captured image and the second captured image.

5. The optical inspection apparatus according to claim 1, wherein
the imaging portion includes an imaging optical element configured to image the object and a first light selection portion that is provided on a focal plane of the imaging optical element and is configured to control passage of light.

6. The optical inspection apparatus according to claim 1, wherein
the illumination portion includes an imaging optical element configured to illuminate the object and a second light selection portion that is provided on a focal plane of the imaging optical element and is configured to control passage of light.

7. The optical inspection apparatus according to claim 6, wherein
the second light selection portion is axisymmetric.

8. The optical inspection apparatus according to claim 6, wherein
the second light selection portion has translational symmetry in a uniaxial direction.

9. The optical inspection apparatus according to claim 6, wherein
the second light selection portion has a distribution in an azimuthal angle direction.

10. The optical inspection apparatus according to claim 1, wherein
the processor is configured to measure a shape of the object.

11. The optical inspection apparatus according to claim 1, wherein
the processor is configured to inspect a surface of the object or an inner surface of the object.

12. An optical inspection method comprising:
irradiating at least a first object point of an object with a light beam flux at a first solid angle by first illumination light from an illumination portion, a solid angle not including the first solid angle being set as a second solid angle;
acquiring a first captured image of the object using an imaging portion by illumination with the first illumination light;
setting a solid angle included in the first solid angle as a third solid angle, setting a solid angle included in the second solid angle as a fourth solid angle, and irradiating at least the first object point with light beam fluxes at the third solid angle and the fourth solid angle by second illumination light from the illumination portion;
acquiring a second captured image of the object using the imaging portion by illumination with the second illumination light; and
acquiring information regarding the object by the first captured image and the second captured image.

13. The optical inspection method according to claim 12, wherein in a case where an object point different from the first object point of the object is set as a second object point,
the irradiating at least the first object point of the object with the light beam flux at the first solid angle includes irradiating the second object point in addition to the first object point, and
the irradiating at least the first object point with the light beam fluxes at the third solid angle and the fourth solid angle includes irradiating the second object point in addition to the first object point.

14. The optical inspection method according to claim 12, wherein
the irradiating with the light beam flux at the first solid angle by the first illumination light from the illumination portion includes irradiating with a light beam flux having a first wavelength spectrum,
the irradiating with the light beam fluxes at the third solid angle and the fourth solid angle by the second illumination light from the illumination portion includes irradiating with a light beam flux having the first wavelength spectrum, and
the first illumination light and the second illumination light are emitted at different times.

15. The optical inspection method according to claim 12, further comprising simultaneously
irradiating at least the first object point of the object with a light beam flux having a first wavelength spectrum at the first solid angle as the first illumination light and
irradiating at least the first object point with light beam fluxes having a second wavelength spectrum different from the first wavelength spectrum at the third solid angle and the fourth solid angle as the second illumination light.

16. The optical inspection method according to claim 12, further comprising:
forming a fifth solid angle and a sixth solid angle with respect to the third solid angle such that the fifth solid angle and the sixth solid angle have a relationship similar to a relationship between the third solid angle and the fourth solid angle with respect to the first solid angle;
forming a seventh solid angle and an eighth solid angle with respect to the fourth solid angle such that the seventh solid angle and the eighth solid angle have a relationship similar to a relationship between the third solid angle and the fourth solid angle with respect to the first solid angle;
irradiating at least the first object point of the object with light beam fluxes at the fifth solid angle, the sixth solid angle, the seventh solid angle, and the eighth solid angle by third illumination light; and
acquiring a third captured image of the object using the imaging portion by illumination with the third illumination light,
wherein the acquiring the information regarding the object by the first captured image and the second captured image includes acquiring information regarding the object by the first captured image, the second captured image, and the third captured image.

17. A non-transitory storage medium storing an optical inspection program for causing a computer to execute:
causing at least a first object point of an object to be irradiated with a light beam flux at a first solid angle by first illumination light from an illumination portion, setting a solid angle not including the first solid angle as a second solid angle;
acquiring a first captured image of the object using an imaging portion by illumination with the first illumination light;
setting a solid angle included in the first solid angle as a third solid angle, setting a solid angle included in the second solid angle as a fourth solid angle, and causing at least the first object point to be irradiated with light beam fluxes at the third solid angle and the fourth solid angle by second illumination light from the illumination portion;
acquiring a second captured image of the object using the imaging portion by illumination with the second illumination light; and
acquiring information regarding the object by the first captured image and the second captured image.
